(19) United States
(12) Patent Application Publication
(10) Pub. No.: US 2011/0295620 A1
(43) Pub. Date: Dec. 1, 2011

(54) METHOD, APPARATUS AND SYSTEM FOR AUTOMATED PATIENT SCREENING AND TRIAGE

(75) Inventors: Matthew Joseph LOSCALZO, Sierra Madre, CA (US); Karen Lynn Clark, Carlsbad, CA (US)

(73) Assignee: CITY OF HOPE, Duarte, CA (US)

(21) Appl. No.: 13/117,733

(22) Filed: May 27, 2011

Related U.S. Application Data
(60) Provisional application No. 61/349,589, filed on May 28, 2010.

(51) Int. Cl. G06Q 50/00

(52) U.S. Cl. 705/3

(57) ABSTRACT

A computer-based screening instrument system and method comprising a patient interactive device coupled with a data network and an administrative server, the administrative server operatively connected to a database and a printer, wherein the administrative server is configured to serve as a screening instrument to the patient interactive device and to receive responsive information from the patient interactive device; and a triage module, wherein the screening instrument comprises a plurality of issues, an issue having a patient prompt and one or more patient selectable responses, wherein the patient interactive device, for each issue in the screening instrument, displays the related patient prompt, receive an indication of a patient selection of a related patient selectable response and transmit information representing the indication to the administrative server; wherein the administrative server receives the information and stores a patient response record comprising the information received; wherein the triage module compares a particular patient's response record with a set of triage rules and performs at least one of the following: (1) generate and transmit a triage message indicating a patient exigency to a communication device of a member of the patient's professional health care team, and (2) generate and transmit a message indicating the patient's request to discuss an issue with a member of the patient's professional health care team to the communication device.

### CROSS-REFERENCE TO RELATED APPLICATIONS

This application is based upon and claims priority from U.S. provisional patent application No. 61/349,589, filed May 28, 2010, the contents of which application being incorporated herein by reference, in its entirety.

### BACKGROUND OF THE INVENTION

1. Field of the Invention

The present invention relates to systems, apparatuses and methods for identifying, analyzing, recording and taking actions through a patient screening system. Screening can be with regard to patient biopsychosocial issues. Patients can be provided with a personal interactive device for surveying patient information, e.g., biopsychosocial-related information, which is analyzed and transmitted in real-time to make patient care decisions.

2. Description of the Related Art

As demands on physician time mount, and sophisticated patients and families increasingly expect accommodation and understanding of their specific, personal situations, care providers must boost efficiency and minimize the expense of their clinic processes and draw on connections with community resources. Third-party payers are also expecting that the biopsychosocial needs of patients and families be addressed as an essential part of cancer care. Quality of care, cost, patient satisfaction, adherence to treatment, safety, and allocation of limited resources are all related to the identification and effective management of the psychosocial elements of cancer care. While embodiments of the present invention are occasionally discussed below in terms of cancer care, embodiments are not so limited and can be applied to any physiological or psychological human concern.

As many as 47% of cancer patients have been shown to experience emotional distress at the level of a diagnosable psychiatric disorder. However, patients experience distress that is caused by more than psychiatric problems. Informational, educational, social, psychological, spiritual, financial, and practical problems, even in the absence of mental illness, can also cause disabling distress. The psychosocial impact of physical symptoms, alone or in combination with issues such as depression, anxiety, and financial vulnerability, also influence the ability to cope and manage the many demands endemic to the cancer experience. Identifying and managing the biopsychosocial domains can seem to be a time-consuming and daunting task for physicians when they have increasingly less time to spend with patients. This is true in both large academic cancer centers and small community practices.

Several studies have shown the financial-offsetting advantages of addressing biopsychosocial issues, despite the effort and cost of establishing a screening and triage system. These include cost benefits to hospitals providing psychosocial care, and the potential for psychological distress screening to predict and intervene in patient treatment noncompliance, appointment-breaking, and clinical trial discontinuation.

The early identification of patient, and in some cases the family caregiver, biopsychosocial problems is essential to relieve distress, prevent crises, and minimize system disruption. Potential barriers preventing identification of these problems include stigma, lack of a common language, health care professional avoidance of emotional content, lack of professional training to acquire this information, and the belief that these problems are less important than physical care. In addition to the barriers endemic to identification and communication of biopsychosocial vulnerabilities, system-based barriers also exist, such as the lack of a standardized comprehensive approach to the identification of biopsychosocial problems. The National Comprehensive Cancer Network (NCCN) and the Institute of Medicine (IOM) recommend psychosocial distress screening for all patients to address problems before a crisis develops and necessitates higher levels of intervention. Some screening instruments, such as the Distress Thermometer and the Edmonton Symptom Assessment Scale, have been developed to address these needs and recommendations.

Although patients want their health care team to engage them as whole persons, patients can still express considerable hesitation based on social stigma and fear associated with certain medical conditions such as cancer. Although some stigmas are decreasing, the emotional, psychosocial, psychiatric, and financial problems endemic to certain conditions have been much more resistant to change. Physicians and nurses, however, can play a major role in encouraging patients to voice their illness-related concerns. Instituting biopsychosocial screening for all patients early in the clinical encounter can communicate an openness and sense of hope that patients and families can manage any barriers related to their medical care. Patients do not expect their physicians and nurses to fix their illness-related problems, but they do have the minimum expectation that the health care professionals, on whom they depend for their care, be knowledgeable about mental health and other essential resources in their community. The most efficient and reliable way to identify the essential needs and barriers for patients is through biopsychosocial screening.

Biopsychosocial screening has gained increasing acceptance. In many settings, biopsychosocial screening is performed with paper and pencil. See, for example, FIG. 1A, a check list, FIG. 1B a distress thermometer, and FIG. 1C, an optical mark screening instrument. However, paper screening tools are time-consuming for staff to review, analyze, and use to make referrals, limiting their use. Further, the identification and recording of relevant information is often missed in paper settings. In addition, information obtained with these tools is not consistently delivered to the physician in time for discussion during the clinical encounter.

As physician time is increasingly consumed with seeing growing numbers of patients because of decreased reimbursement and increased administrative demands, such as authorizations and use review, physicians have less time to spend with each individual patient. It has long been shown, however, that the quality of the clinical encounter, not just the time spent with the patient, is associated with better health outcomes and higher patient satisfaction. Patients can experience their clinical encounters as stressful and emotionally charged. Within this context, patient-physician communication is primarily focused on disease-directed information at the expense of critical biopsychosocial domains.

Thus, there is a need for a system, method and apparatus to effectively collect patient biopsychosocial information and provide for automated screening and action, thereby promoting physician control in managing time, the efficiency of the clinical encounter, and rapid triage to other professionals and community resources. There is a need for a system, method and apparatus to decrease resource intensity while providing enhanced timely communication, tailored interventions, clinical summaries, and a database that is immediately updated and available for better understanding of the specific characteristics of the patient populations being served. There is a need for a system, method and apparatus to collect patient biopsychosocial information using a common language, a normalization of problems and a decrease in concerns about stigma.

### BRIEF SUMMARY OF THE INVENTION

In accordance with an embodiment of the invention, there is provided a screening instrument system having a patient interactive device and an administrative server, both coupled with a data network. The administrative server is operatively connected to a database and a printer and is configured to serve a screening instrument to the patient interactive device and to receive responsive information from the patient interactive device. A screening instrument includes issues comprising a patient prompt and one or more patient selectable responses. The patient interactive device is operable to, for each issue in the screening instrument, display the related patient prompt, receive an indication of a patient selection of a related patient-selectable response and transmit information representing the indication to the administrative server. The administrative server is configured to receive the information and store a patient response record comprising the information received. The system also includes a triage module configured to compare a particular patient's response record with a set of triage rules and perform at least one of the following: (1) generate and transmit a triage message indicating a patient exigency to a communication device of a member of the patient's professional health care team, the communication device operatively connected to the data network, and (2) generate and transmit a message indicating the patient's request to discuss an issue with a member of the patient's professional health care team to the communication device.

In accordance with one embodiment, the triage module is further configured to generate and transmit a summary report of the patient's response record to the communication device and the printer. In accordance with one embodiment, the patient interactive device is a touch screen computer. According to one embodiment, an issue can further have a triage threshold and identify a triage alert professional. The triage message is automatically transmitted to a communication device of the identified triage alert professional when a patient response to an issue matches or exceeds the triage threshold associated with the issue. In accordance with one embodiment, an issue further comprises information identifying an educational item, and the administrative server is further configured to retrieve the educational item from an educational item store and to transmit the educational item to the printer in response to information representing the patient's desire for additional information.

In accordance with another embodiment of the present invention, a computer-based method of administering a screening instrument is provided. The method has a step of storing a screening instrument in an electronic screening instrument store, the electronic screening instrument store operatively connected to an administrative server. The screening instrument includes issues, each issue having a patient prompt and one or more patient selectable responses. The method also has steps of transmitting, by the administrative server, each issue to a patient interactive device via a data network; receiving from the patient interactive device, by the administrative server, patient response data representing a patient's selected responses to the screening instrument issues; and storing, in a database, the responses as an electronic patient record. The method also has a step of triaging, by the administrative server. Triaging includes electronically comparing one or more data representing the patient's responses with a set of triage rules and performing at least one of the following: (1) electronically generating and transmitting an triage message indicating a patient exigency to a communication device of a member of the patient's professional health care team, the communication device operatively connected to the data network, and (2) electronically generating and transmitting a message indicating the patient's request to discuss an issue with a member of the patient's professional health care team to the communication device.

In accordance with one embodiment, the step of triaging further includes generating and transmitting a summary report of the patient's responses to the communication device and to a printer operatively connected to the administrative server. In accordance with one embodiment, an issue further comprises information identifying an educational item and the method has steps of retrieving, by the administrative server, the educational item from an electronic educational item store; and transmitting the educational item to a printer operatively coupled to the administrative server in response to information representing the patient's desire for additional information.

In yet another embodiment of the present invention, a computer-readable medium containing computer-executable instructions for administering a patient screening instrument is provided. The computer instructions include instructions for retrieving a patient screening instrument from an electronic screening instrument store, the patient screening instrument comprising a plurality of issues, each issue comprising a patient prompt and one or more patient selectable responses. The computer instructions include instructions for transmitting each issue to a patient interactive device via a data network and receiving from the patient interactive device patient response data representing a patient's responses to the screening instrument items. The computer instructions include instructions for triaging, where triaging includes comparing data representing the patient's responses with a set of triage rules and performing at least one of the following: (1) generating and transmitting an triage message indicating a patient exigency to a communication device of a member of the patient's professional health care team, the communication device operatively connected to the data network, and (2) generating and transmitting a message indicating the patient's request to discuss an issue with a member of the patient's professional health care team to the communication device

In one embodiment, the computer-executable instructions for triaging further include instructions for generating and transmitting a summary report of the patient's responses to the communication device and to a printer operatively connected to the administrative server. In an embodiment, an issue can further comprise a triage threshold and identify a triage alert professional and the computer executable instructions further include instructions for transmitting the triage message to a communication device of the identified triage alert professional when a patient response to an issue matches or exceeds the triage threshold associated with the issue. In an embodiment, an issue further includes information identifying an educational item and the computer executable instructions further include instructions for retrieving the educational item from an educational item store and transmitting the educational item to a printer in response to information representing the patient's desire for additional information.

A further embodiment is directed to an individual screening and triage system, including a patient interactive device; an administrative server; a data network operatively connected to at least the patient interactive device and the administrative server, wherein issues and prompts are directed from the administrative server over the data network to the patient interactive device and responses are received at the administrative server from the patient interactive device; and a triage module, wherein the patient interactive device presents the issues and related possible prompts to a user of the patient interactive device and transmits the user responses over the data network; wherein the user responses can include data and information related to the presented issue; wherein the administrative server receives the transmitted data and information for storage into a patient record; and wherein the triage module is configured to compare a user's response data and information with a set of triage rules and, if the response triggers a triage message, automatically generate and transmit a triage message indicating a patient exigency to a communication device of a member of the user's care team.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and enable a person skilled in the pertinent art to make and use the invention. In the drawings, like reference numbers indicate identical or functionally similar elements.

FIGS. 1A-C illustrate prior art biopsychosocial screening instruments.

FIG. 2 illustrates a screening instrument and triage system according to an embodiment of the invention.

FIGS. 3A-3D depict exemplary touch screen computing devices in accordance with embodiments of the invention.

FIG. 4 illustrates a method in accordance with an embodiment of the invention.

FIGS. 5A-5B illustrate touch screen computing device screen captures according to embodiments of the invention.

FIG. 6 illustrates a summary report for medical professionals generated by a system according to an embodiment of the invention.

FIGS. 7A-7L illustrate screen captures of administration features in accordance with an embodiment of the invention.

FIG. 8 illustrates exemplary data flow according to an embodiment of the patient screening and triage system.

FIGS. 9A-9K illustrate a cumulative report generated by a system according to an embodiment of the invention.

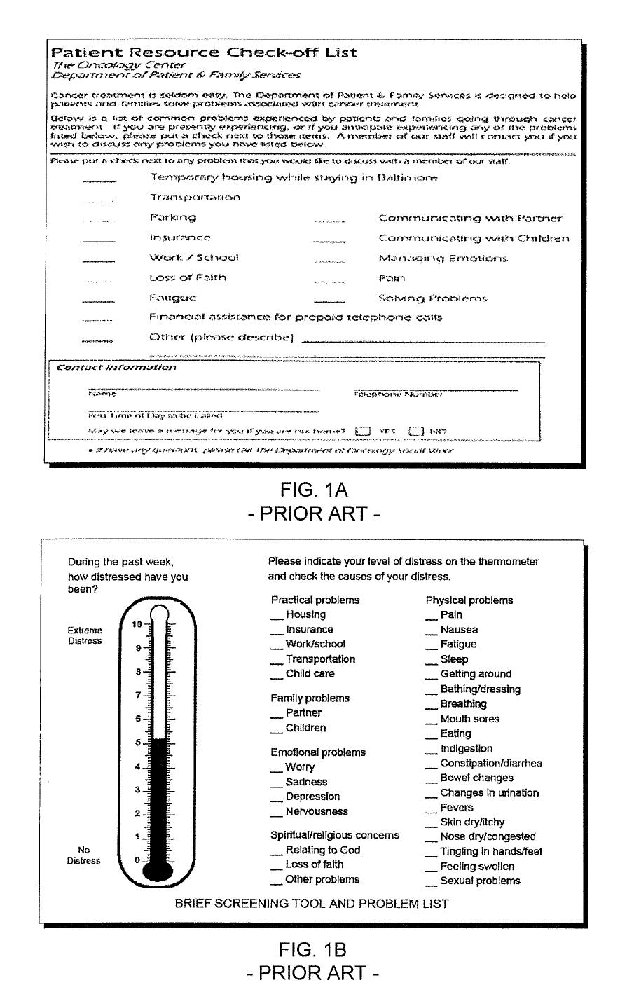

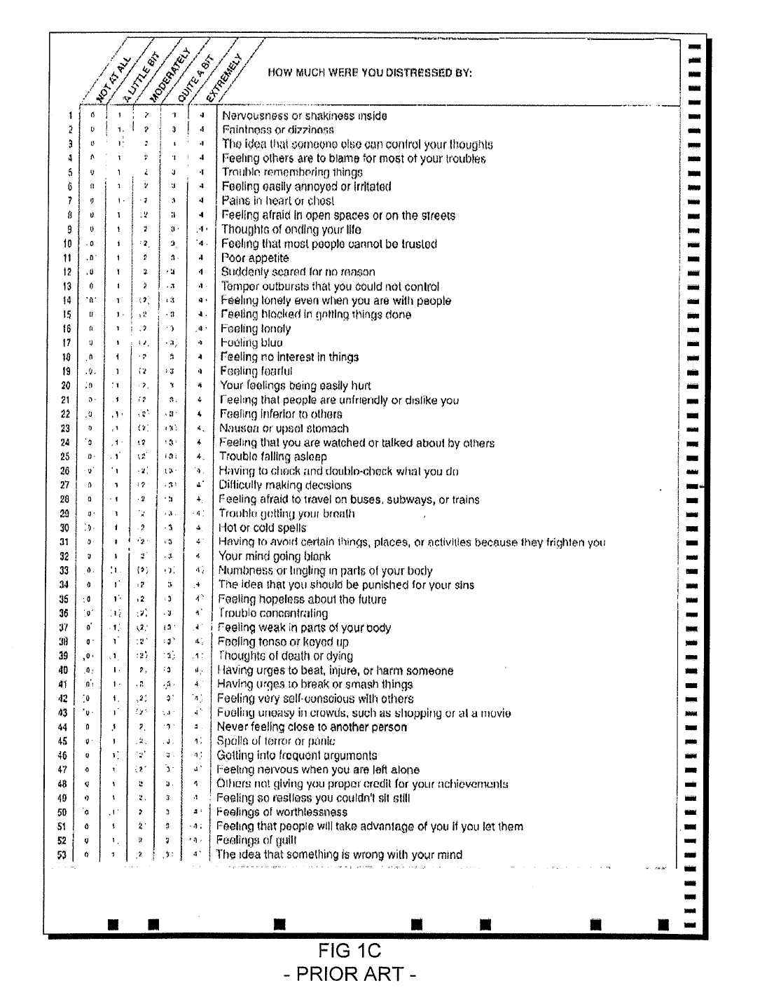

### DETAILED DESCRIPTION OF THE INVENTION

Aspects of the present invention provide for a patient-friendly automated process to identify, triage, and take action based on patient-provided information, e.g. biopsychosocial information, in real time. Embodiments of the present invention can facilitate the process of biopsychosocial screening, from initiation of patient responses to the generation of referrals and provision of educational information. Embodiments of the present invention also can facilitate patient, physician, and multispecialist communication and are used to maximize the effectiveness of clinical encounters and overall care.

People confronted with the vicissitudes of serious illness must first learn to effectively communicate properly with their health care team to adapt to the reality of illness, make difficult decisions, identify barriers to care, and actively participate in rehabilitation and palliation. The present invention can become a foundation for an evolving partnership through systematic electronic communication among patients and their primary health care team and the multispecialists involved in their medical care.

While details and the scope of the inventive screening and triage instrument system and method are discussed above and below regarding interacting with a patient and the patient's caregiving team, the inventive coverage of the systems and methods is not so limited. The features disclosed herein can be applied equally effectively with the individual caregivers and the family members of a patient. In such extended applications, the caregivers and/or the family members can participate in the screening and triage process whereby these individuals can provide information and can be instructed how to proceed on behalf of the patient's interests. For example and not limitation, the system can expand its patient screening and triage coverage to include such professionals as nutritionists, rehabilitation specialists, financial advisers, and the like. In this manner, the screening and triage system and methodology becomes a total patient care system in which all members of the patient's extended care team can be involved, screened, triaged, instructed, and monitored.

Actions by each team member can be monitored by the system and/or entered into the system and linked to the patient to verify that proper and/or recommended actions on behalf of the patient were actually and timely performed. In this manner, patient satisfaction and patient safety goals are incorporated into the system, including the opportunity for feedback through the system from each and any of the patient's caregiving team. Should recommended actions not be timely or completely performed, a corresponding message can automatically be generated and transmitted to a selected one or more members of the patient's caregiving team and/or to the patient.

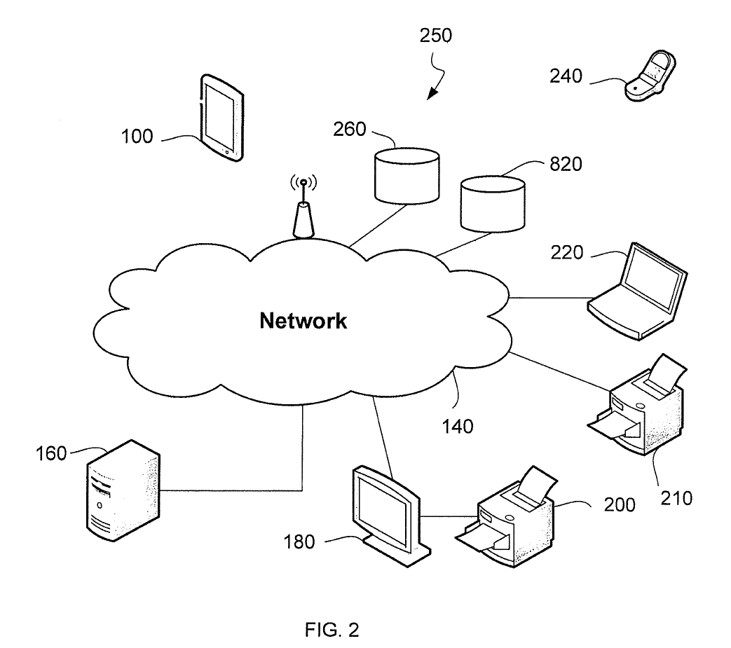

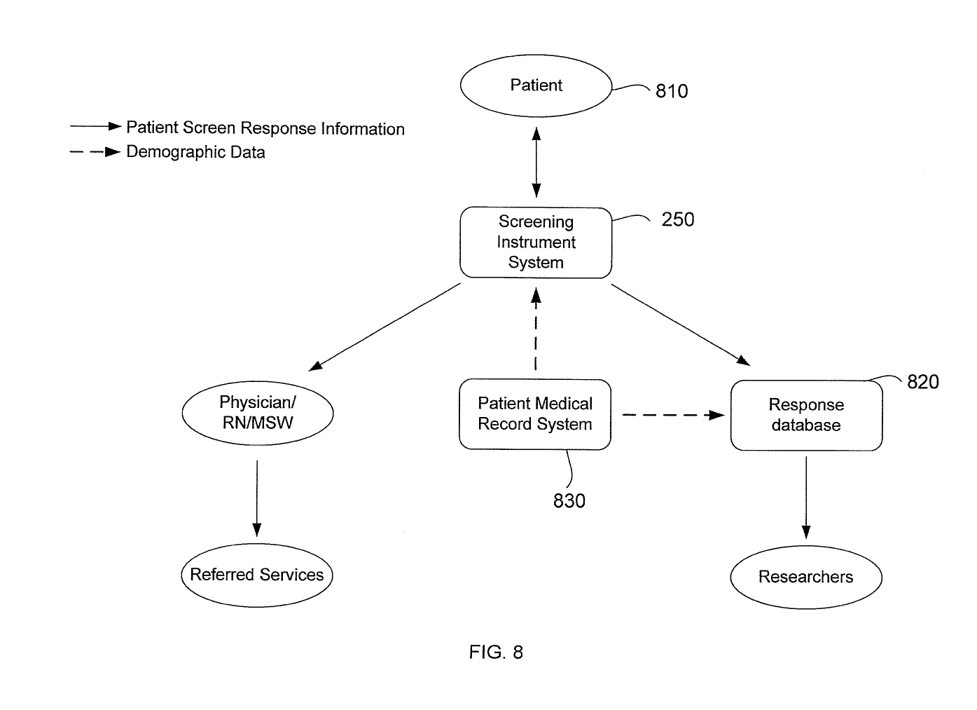

With reference to FIGS. 2 and 8, an exemplary patient clinic check-in process and screening instrument system 250 in accordance with an embodiment of the invention are disclosed. A patient 810 can check in for their appointment with the clinic front desk staff. Staff can be provided a script to read to the patient saying, for example, “We have a short questionnaire that we would like you to complete. By completing this form you will tell us how we can best work together with you as an effective team.” The script can be laminated and attached to a staff member workstation. The staff then identifies the patient to the screening instrument system 250 by, for example, their medical record number, name and/or birth date. To minimize patient and staff burden, demographic variables are prepopulated into the screening instrument system from the medical record system 830 so there is no need for the repetitive identification of basic patient information.

The patient is given a Patient Interactive Device (PID) 100 with brief instructions and is directed to find a comfortable place to sit and complete the screening instrument. The staff can assist, although the screening instrument and PID 100 generally do not require assistance. In one embodiment, the patient can spend approximately 12-15 minutes completing the screening instrument. In an alternate embodiment, the patient can access the functionality of the PID remotely, such as through a network, and provide the information through the PID prior to traveling to the clinic location.

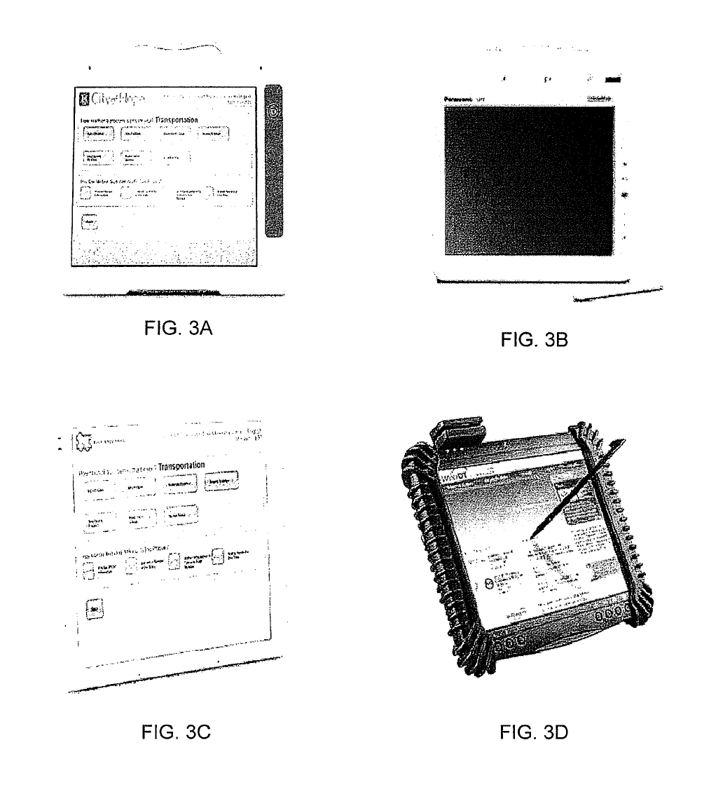

With reference to FIG. 2, in one embodiment, PID 100 can be a node on a wired or wireless computer network 140 in order to communicate with a host/server 160 and other devices accessible through the network connection. The network can include a local area network, a public network such as the Internet, or a Cloud-based network environment. PID 100 can be a hand-held touch screen device such as an Apple iPad or Panasonic Toughbook. Other examples of PIDs are depicted in FIGS. 3A-3D. Touch screen technology enables a keyboard-free interface where users can input data onto the device screen using a stylus or their fingers. The patient is able to interact with PID 100 by seeing content displayed on the device screen and by touching the device screen at appropriate times and in appropriate locations in response to various prompts. Alternately, the PID can have physical keys or buttons with which to enter information and respond to prompts.

Exemplary embodiments are implemented on the computers of the screening instrument system, including the PID(s) 100, server(s) 160, the workstation(s) 180, and the professional's computer(s) 220. Each of the computers 100, 160, 180, and 220 have one or more processors for the processing of software instructions, for analyzing information, for automatically making decisions, and for creating and transmitting output information, reports, and messages. The exemplary computers 100, 160, 180, and 220 are not limited to traditional desk-top computers or laptop computers. Processing, communicating, and data transmitting and receiving functions can be implemented in a number of electronic devices within embodiments covered by the present concepts. For example and not limitation, one or more of the exemplary computers can comprise cellular telephones and/or personal digital assistants, including blackberry-type devices; and the computer users communicate through the computers using known electronic user interfaces.

Computer-executable instructions, or software, are provided for directing the processing of the computers 100, 160, 180, and 220, including processing the steps of exemplary embodiments of the screening instrument system. The computer-executable instructions, when executed by the computers 100, 160, 180, and 220 and/or the processors associated with each of said computers, provide for the presentation of issues and prompts to the patient, receiving information back from the patient, comparing the received information against triage rules, generating a summary report, deciding whether to send a message to one or more members of the patient's health care team, and, if so, transmitting such a message. One or more storage devices 260 and 820 are provided for storage of issues, prompts, patient information, educational information, and/or triage rules utilized in the screening instrument system. The software can be stored on the storage devices, can be loaded into the memory of the computers, or can be stored onto separate storage means within the computers. Further, the software can comprise separate programs and sets of instructions or can be combined into a single program, set of instructions, or program module.

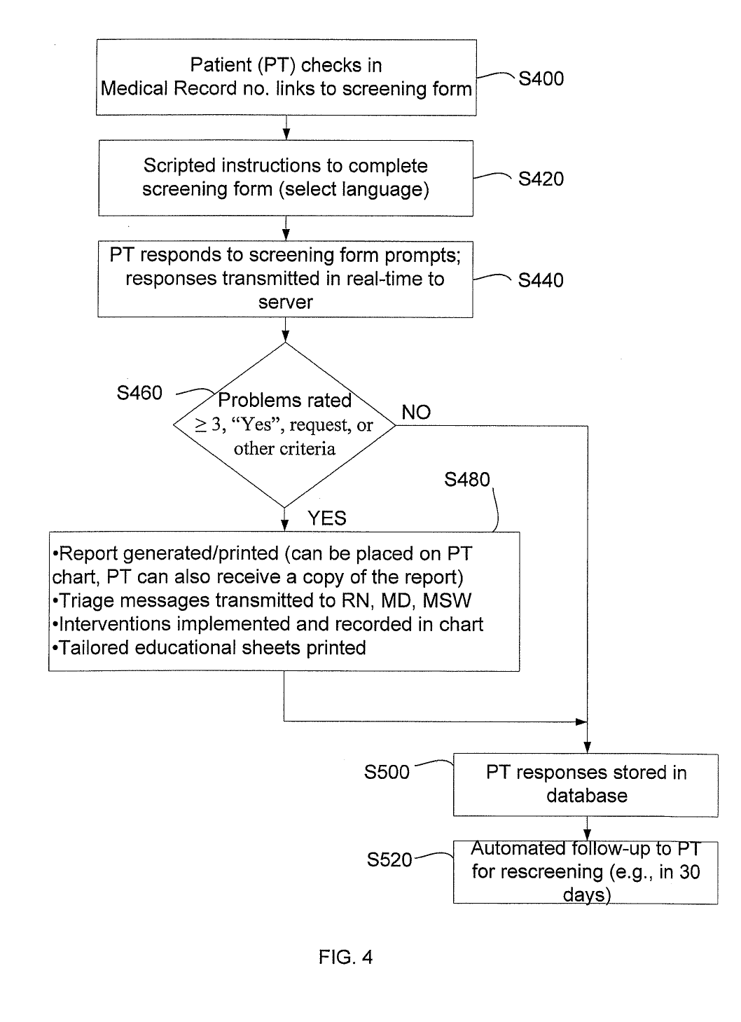

Referring to FIG. 4, in accordance with a method embodying the present invention, there are provided computer-implemented and computer-assisted steps of permitting a patient to check-in S400 at the clinic or other facility, enabling a patient (“PT”) to select a language for a screening instrument S420, and enabling a patient to respond to prompts in a screening instrument S440 in which patient responses can be forwarded in real-time or near real-time to a server. There is also a computer implemented step S460 for determining whether a patient response requires further action. For example, a patient can have responded to a prompt in the screening instrument by indicating a problem of at least a certain severity. Or, a patient can have responded to a prompt by indicating a desire to receive additional information about the issue and/or to speak with a member of the medical team about the issue. An issue can comprise a problem, concern, or question of a patient and/or a prompt item presented to the patient through the PID. Where further action is indicated, there is a step S480 for performing that action. For example, the further action can be generating a report and sending the report to printer 200. The further action can include retrieving educational information from a data store 260 and sending the information to printer 200. The further action can include generating a triage message to an appropriate professional. The method further includes storing patient responses S500 in a database 820 and a step of generating and storing a schedule item S520 for following up with the patient in a certain number of days.

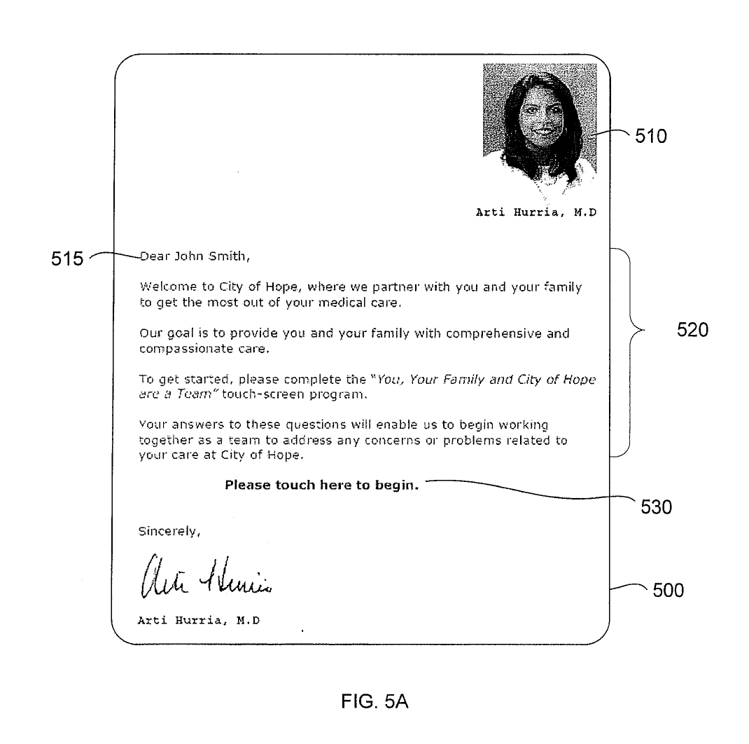

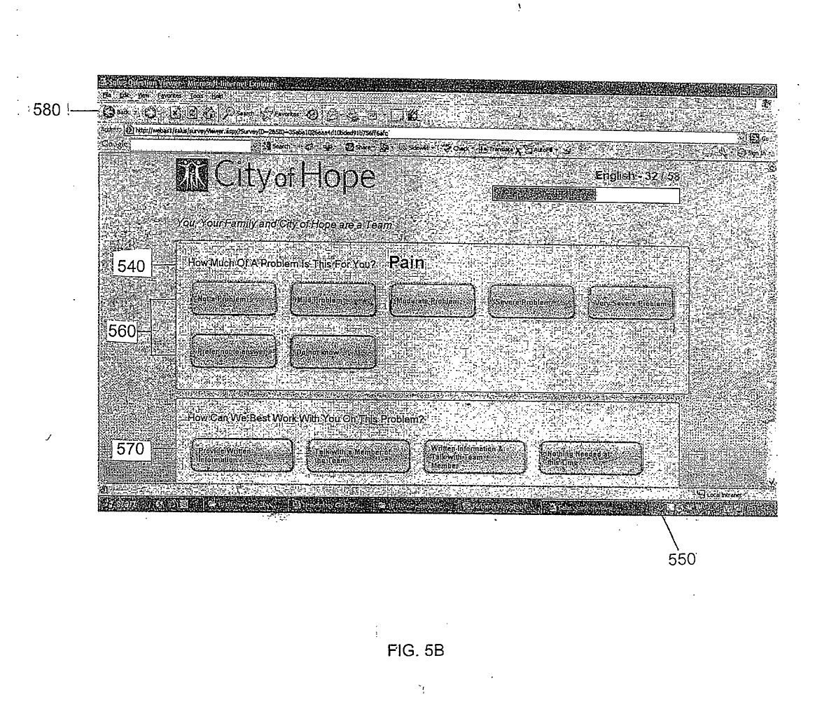

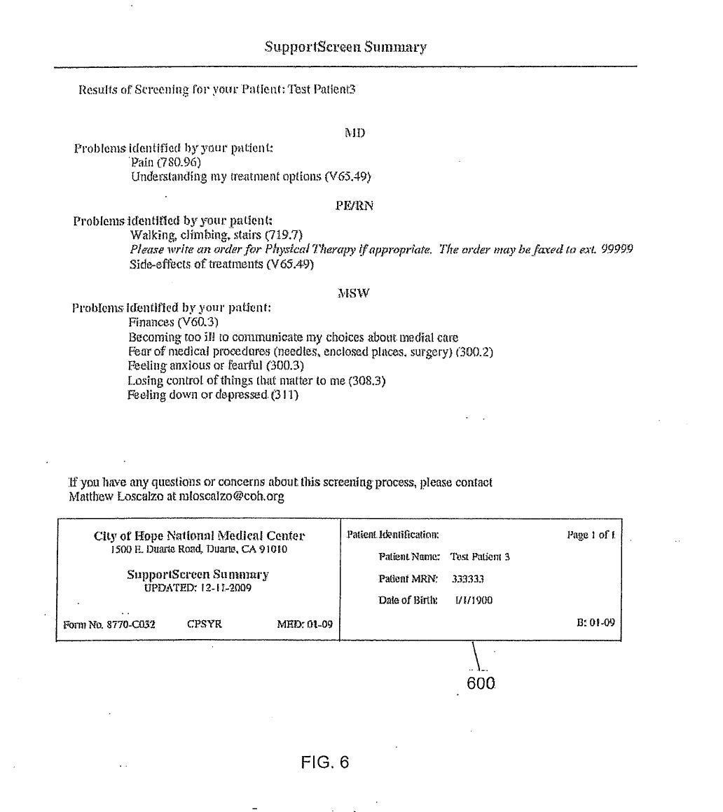

Referring to FIG. 5A, in accordance with an embodiment of the invention, a patient interaction protocol with PID 100 can include display of a welcome letter 500 from a physician. The letter can include the physician's photograph 510 and can be personalized to the patient with the patient's name 515. The welcome letter can have a section 520 to communicate to the patient how the screening process will enable them to be part of the health care team and how this information will be helpful in planning their care and to get to know the patient as a whole person. After reading the letter, the patient can continue to the next part of the interaction protocol by touching PID 100 screen at a prompt location 530 on the screen. In this embodiment, the very first page presented on PID 100 to the patient can convey that the automated screening instrument will be of immediate value to them and not merely another hospital requirement without obvious benefits. Optionally, this letter could inform the patient that the information will be shared with the team and can also be used to guide the patient in how to complete the touch screen.

In accordance with an embodiment of the invention, the patient interaction protocol can include a survey segment. With reference to FIG. 5B, a question screen 550 is displayed to the patient. Question screen 550 can include a question or prompt 540. The patient is able to touch the screen to answer the question or respond to the prompt. Some questions can direct the patient to choose a number from 1 to 5 to represent the degree of a concern or problem, and PID 100 will display the question and 5 touch-screen locations, e.g., buttons, numbered 1-5. The patient can then touch one of the numbers 1-5 in response. Large buttons can be provided. One question per page can be provided. Alternatively, as shown in FIG. 5B, the patient can respond by pushing a button 560 having a descriptive label. For example, if the question asks “How much a problem is this for you?,” the buttons 560 can be labeled “not a problem,” “mild problem,” “moderate problem,” “severe problem,” and “very severe problem.” Optionally, screen 550 includes buttons 560 for “prefer not to answer” and “do not know,” so that patients do not feel forced to provide an answer for each and every question. Visual and audio cues for a page change or automatic page change can be provided. Patients can be asked to rate each of a plurality of problems/questions. In one embodiment, buttons 570 can be provided so that patients can indicate their request to “talk with a member of the team” and/or receive “written information” or “nothing needed at this time.” In some embodiments, the patient can stop or pause the patient interaction protocol with PID 100 and save already entered information for continuation later.

In one embodiment, missing data can be minimized by allowing the patient to proceed to the next screen only when a response has been made to prior prompts or questions. Navigation buttons, such as “Back” button 580 can be provided to allow a patient to navigate to other questions and/or sequences in the screening instrument. PID 100 can also be adapted in view of patient limitations, such as poor eyesight, by providing a larger font and/or visual and audio cues, such as for signaling a page change. Optionally, the language for the screening instrument can be selected to be a non-English language. In some embodiments, two questions can be presented per page. In some embodiments, the response selected by the patient can change color to indicate its selection. For example, in FIG. 5B, “Prefer not to answer” is shown as a selected response in screen 550.

The content of the screening instrument can be adapted based on screening data experience with the present invention or that of prior art paper screening instruments. The exemplary screening items listed in Table 1 are based on screening data experience from over 10,000 cancer patients. In accordance with an aspect of the invention, the screening instrument uses simple language to address common physical, practical, social, psychological, nutritional, physical rehabilitation, and spiritual problems encountered by patients with cancer. In accordance with an embodiment, screening system 250 enables items to be modified, added, or deleted. In one embodiment, the Flesch-Kincaid readability test of screening instrument content can score at a fourth-grade reading level.

TABLE 1
Exemplary Screening Items

Ability to have children
Becoming too ill to communicate my choices about medical care
Being unable to take care of myself
Bowel movement/constipation
Controlling my urine or stool
Eating, chewing, or swallowing difficulties
Fatigue (feeling tired)
Fear of medical procedures
Feeling anxious or fearful
Feeling down or depressed
Feeling hopeless
Feeling irritable or angry
Feeling isolated, alone, or abandoned
Finances
Finding community resources near where I live
Finding meaning or purpose in my life
Finding reliable information about complementary or alternative
practices
Getting medicines
Health Insurance
How my family will cope
Joint limitations
Losing control of things that matter to me
Managing my emotions
Managing work, school, or home life
My ability to cope
Nausea and vomiting
Needing help coordinating my medical care
Needing practical help at home
Pain
Physical appearance
Providing care for someone else
Questions and fear about end of life
Recent weight change
Seriously considering taking my own life
Sexual function
Side effects of treatments
Sleeping
Solving problems because of my illness
Speech
Spiritual or religious concerns
Substance use: you or your environment
Swelling
Talking with doctor
Talking with family, children, and friends
Talking with the health care team
Talking with the health care team about use of food/herbal supplements
while on treatment
Thinking clearly
Tobacco use
Transportation
Understanding my treatment options
Understanding the importance of physical activity even during treatment
Walking climbing stairs
Worry about the future

In addition to the items listed in Table 1, issues and content for specific patient populations, for example geriatric or breast cancer patients, can also be included in the screening instrument.

After the completion of the screening instrument check-in, individual patient response data and information are recorded electronically into a database 820 for action and analysis. Screening server 160 can retrieve information from a data store 260, such as one or more educational sheets responsive to issues identified or information requested by the patient in responding to the screening instrument. After retrieving such materials, it can be printed on printer 200. Alternately, the educational materials or information can be transmitted to a location provided by the patient. Tailored educational written information can be printed in real-time in English or another selected language. Optionally, educational sheets and resources can be personalized by server 160 prior to being printed.

With reference to FIG. 6, screening instrument system 250 can also generate a SupportScreen Summary Report 600. The Summary Report 600, tailored educational information (e.g., talking with your doctor, fertility), and personalized resources requested (e.g., transportation, finances) is automatically generated and printed immediately after the completion of the screening instrument. An e-mail of the Summary Report is transmitted to the patient's primary physician and other health care team professionals, as indicated. The Summary Report is designed for easy identification of problems requiring timely intervention.

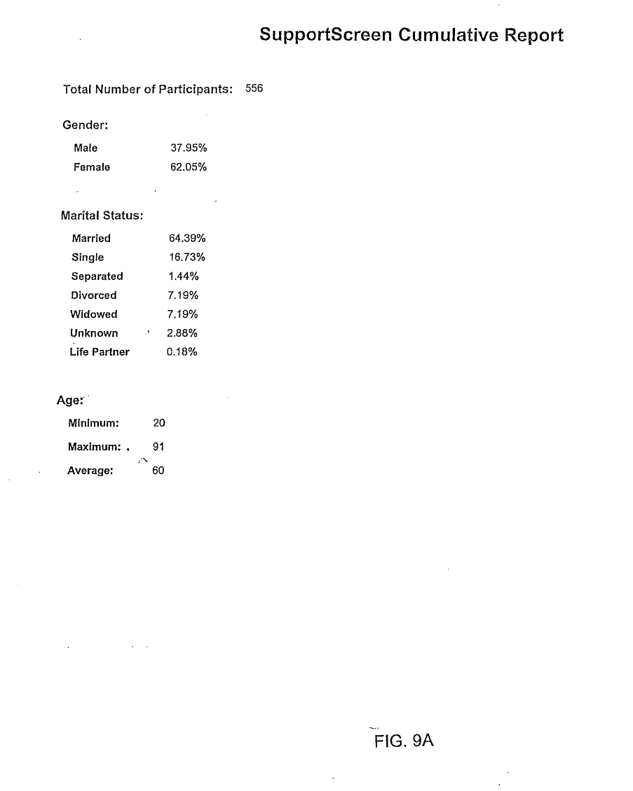

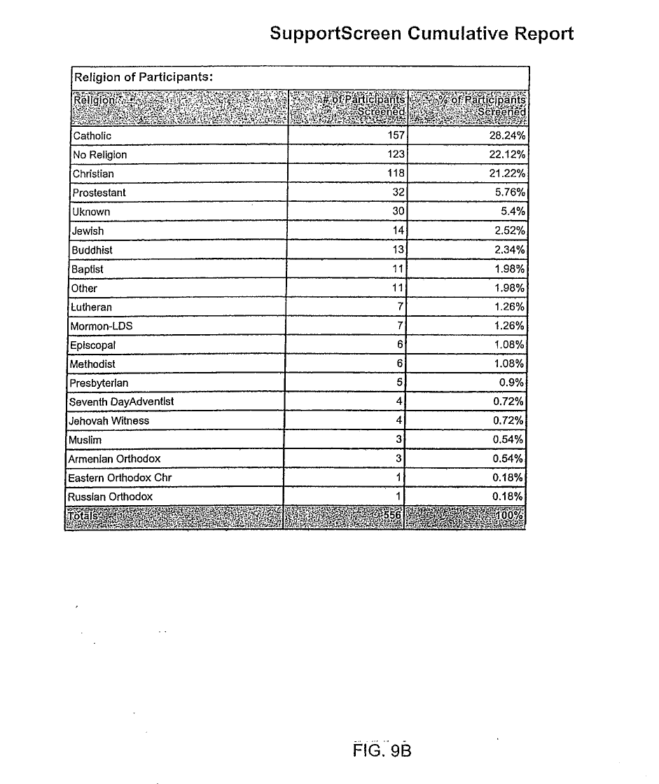

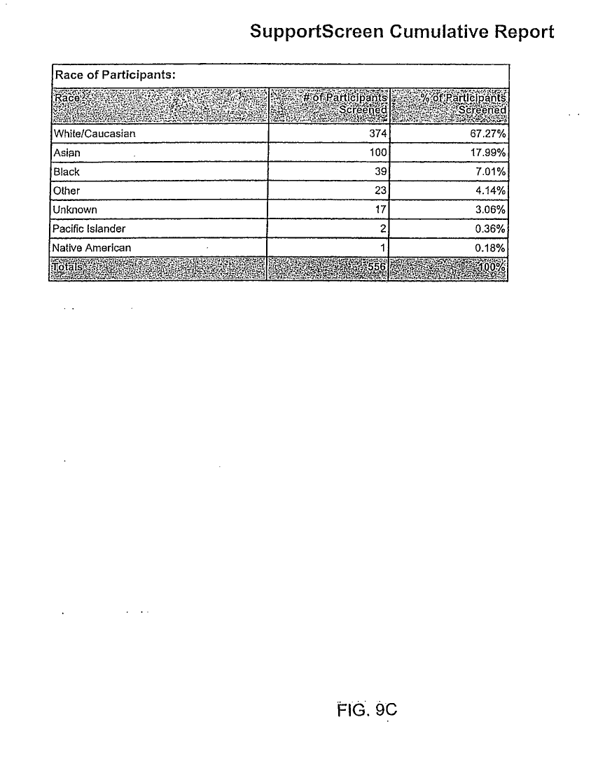

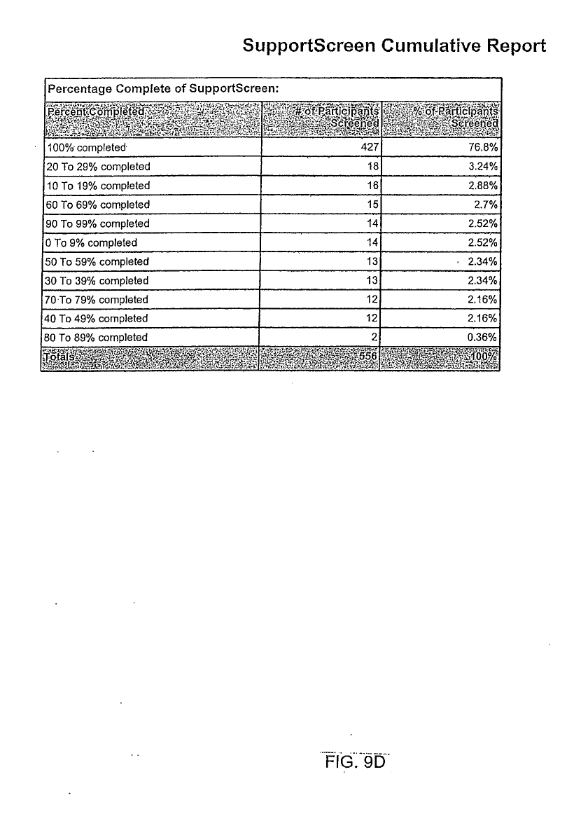

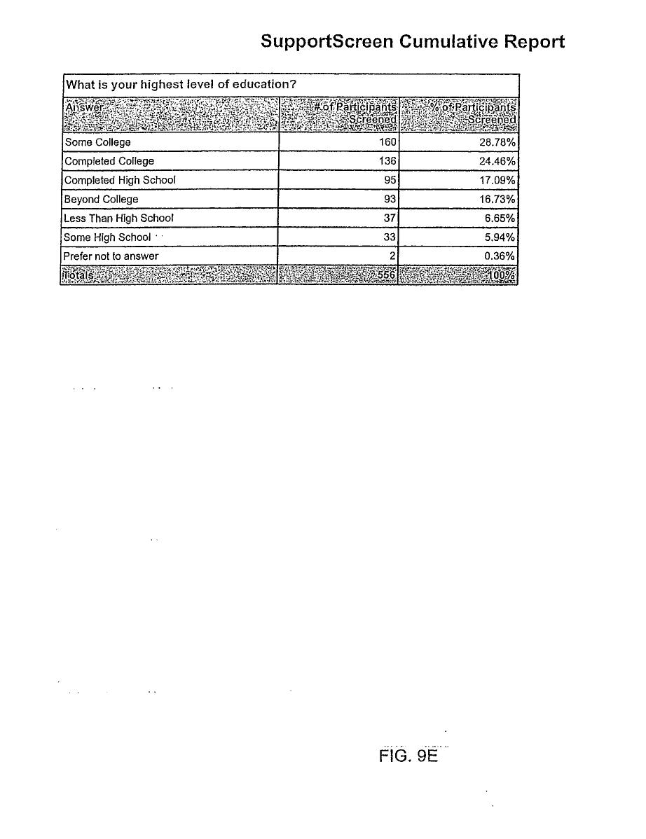

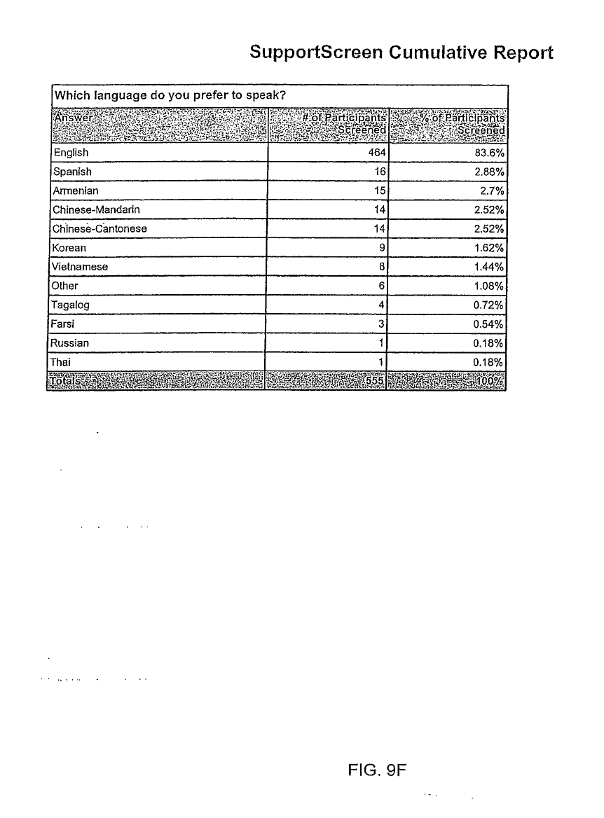

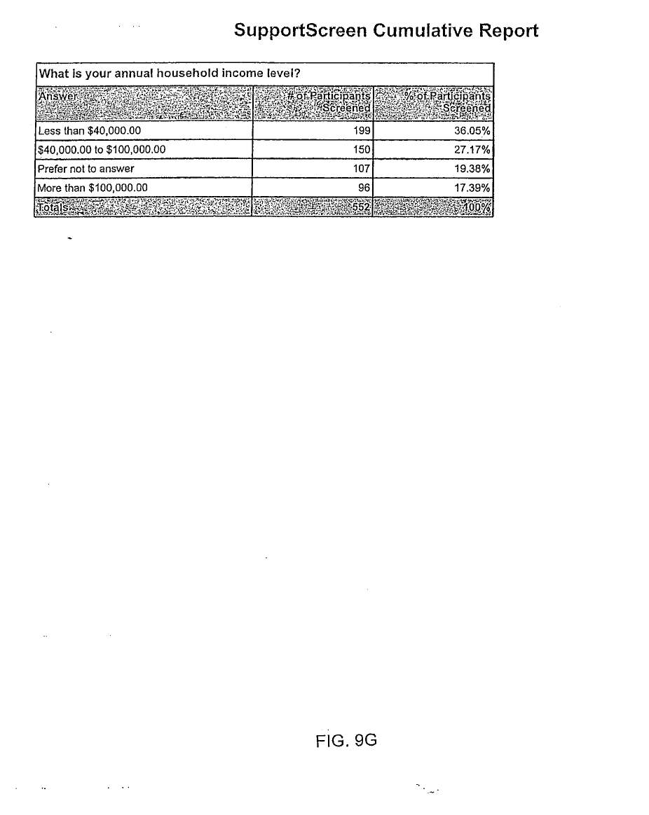

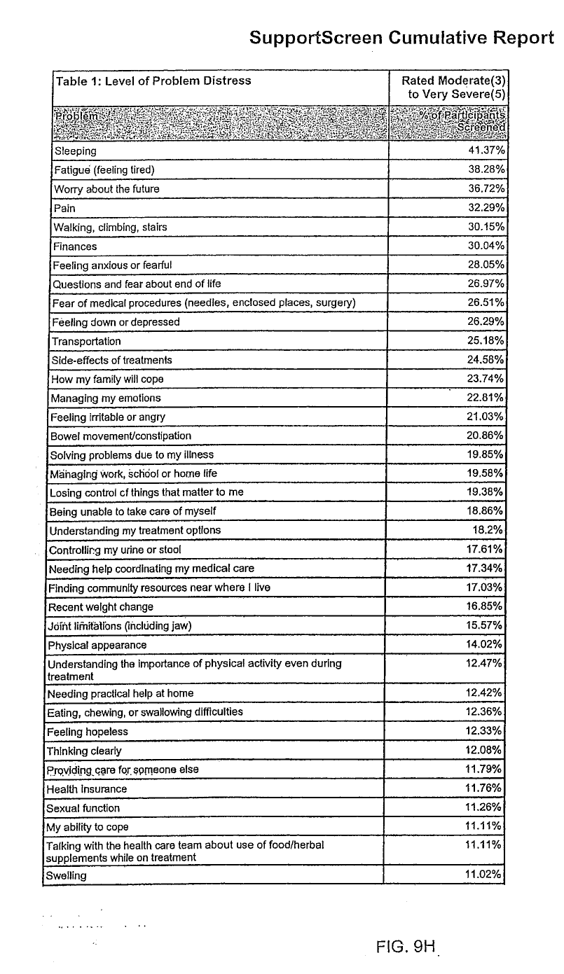

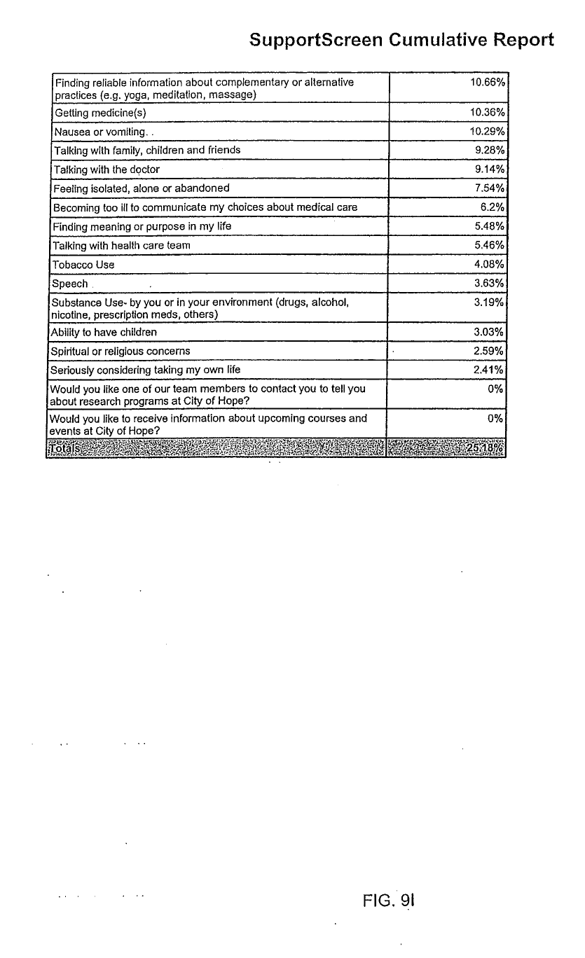

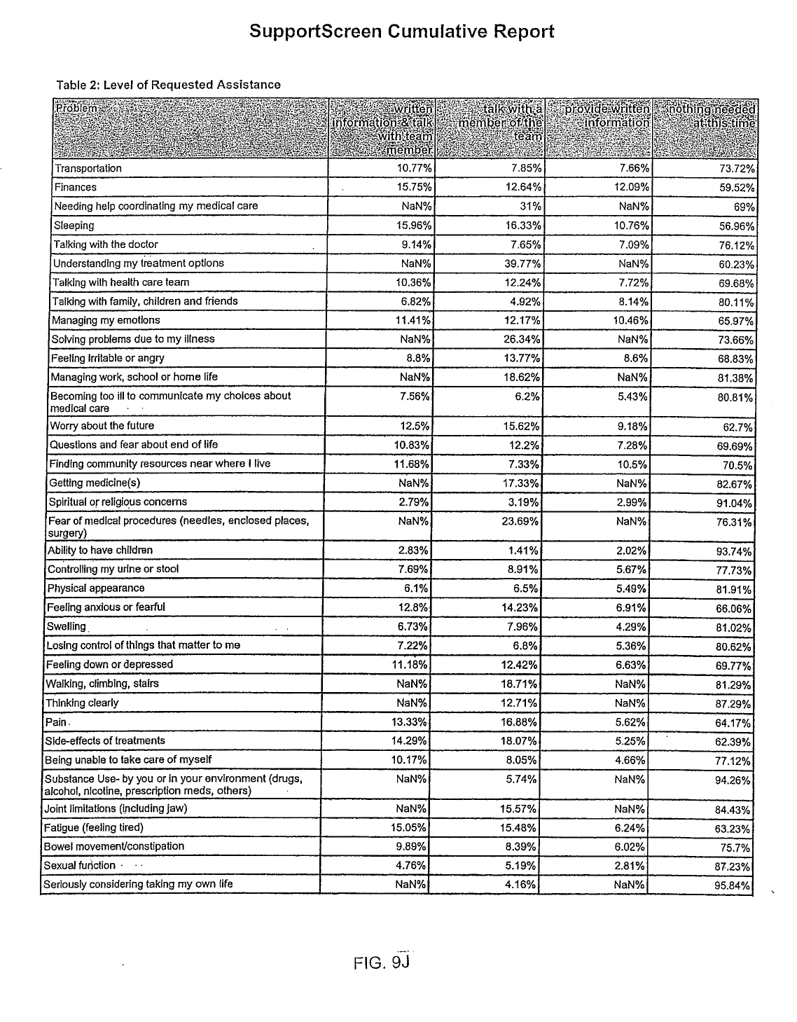

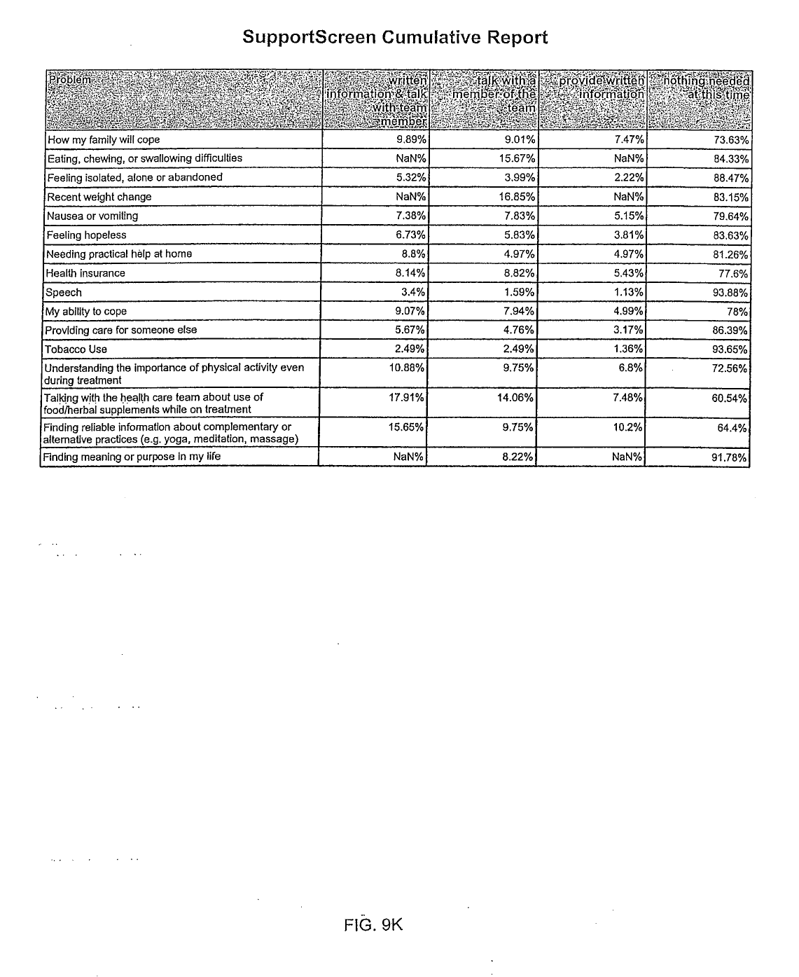

A Cumulative Report, an exemplary portion of which is shown in FIGS. 9A-9K, can be generated by the system, showing aggregate totals, summaries, and break-downs of various categories that have been processed through the screening and triage system. The Cumulative Report can be generated on demand or periodically.

Items in the screening instrument can be precoded, and patient responses can be electronically transmitted to a specific professional or resource in real time according to the precoding. In addition, a copy of the notification is sent to the patient's physician, nurse, and/or social worker to ensure effective ongoing communication. However, screening instrument system 250 is designed to be highly flexible and easily changed to direct the electronic triage and referral information. The NCCN distress management guidelines are one source of information for developing triage, referral, and intervention processes.

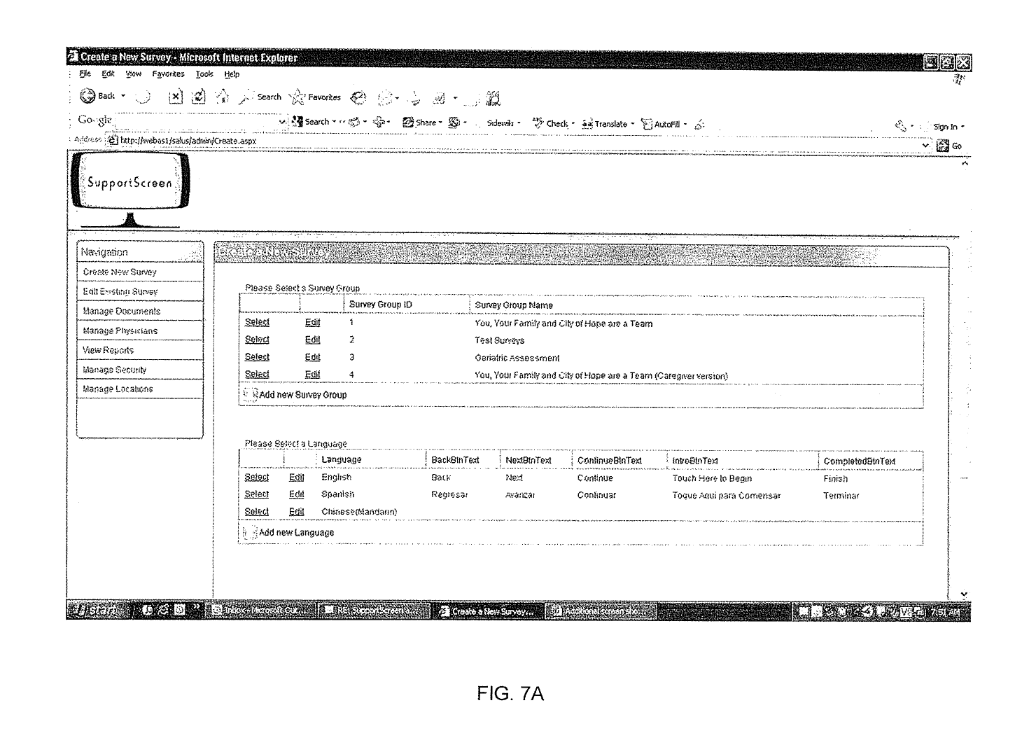

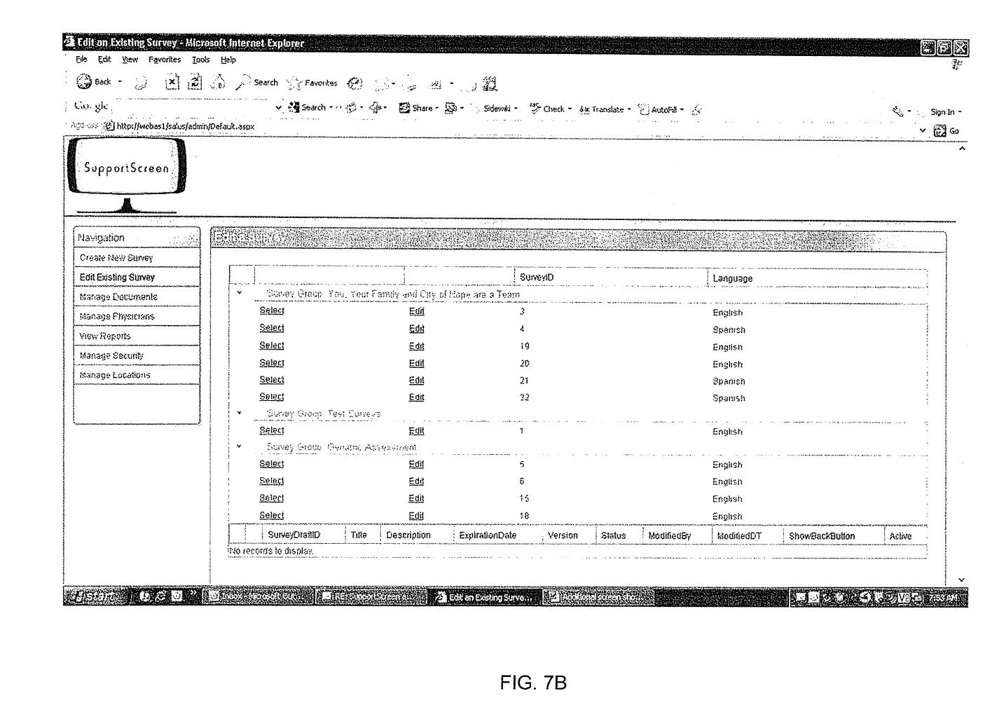

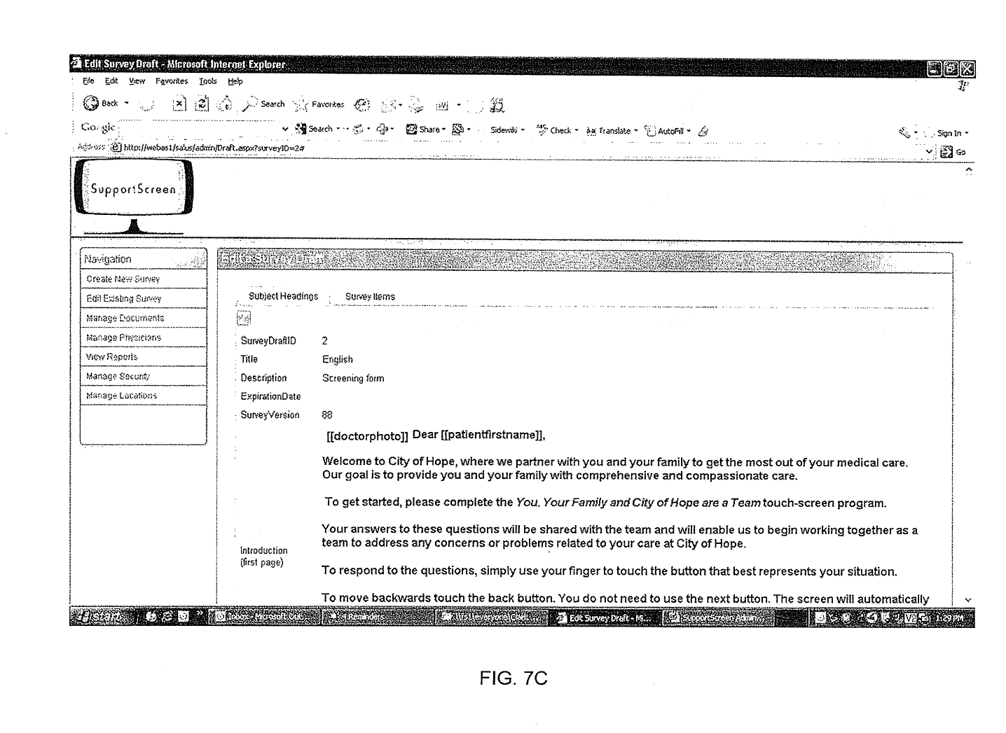

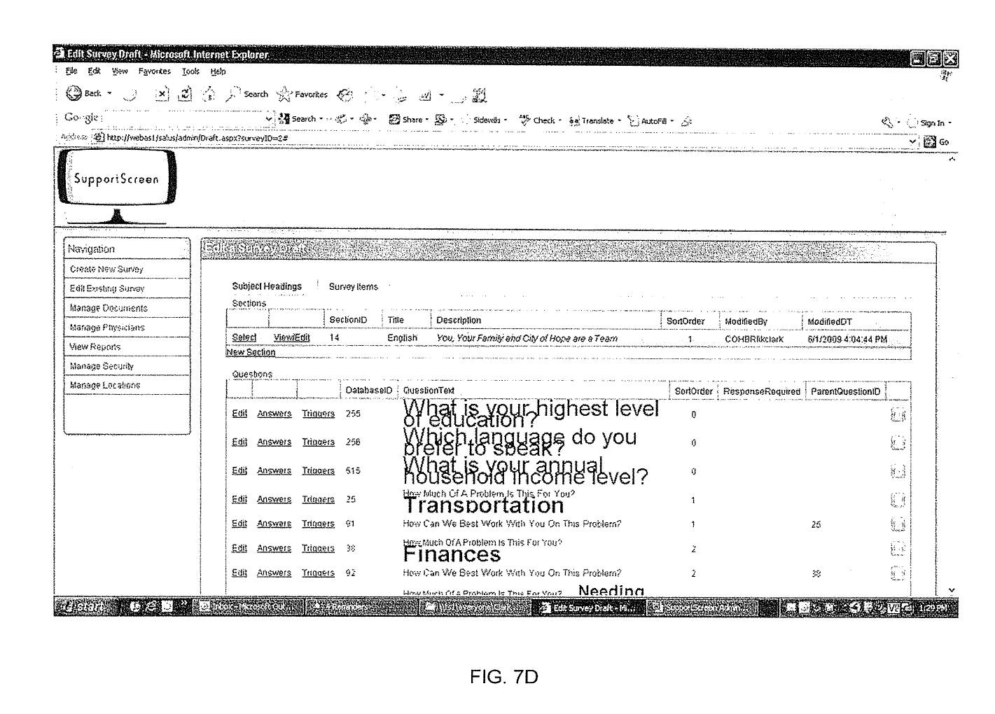

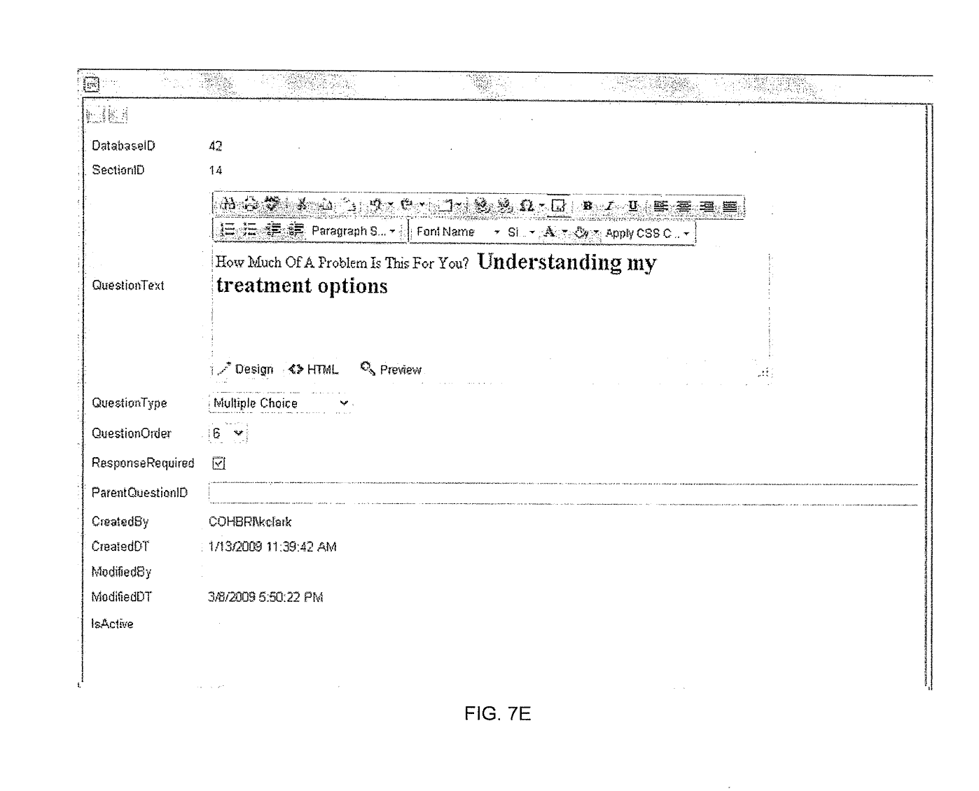

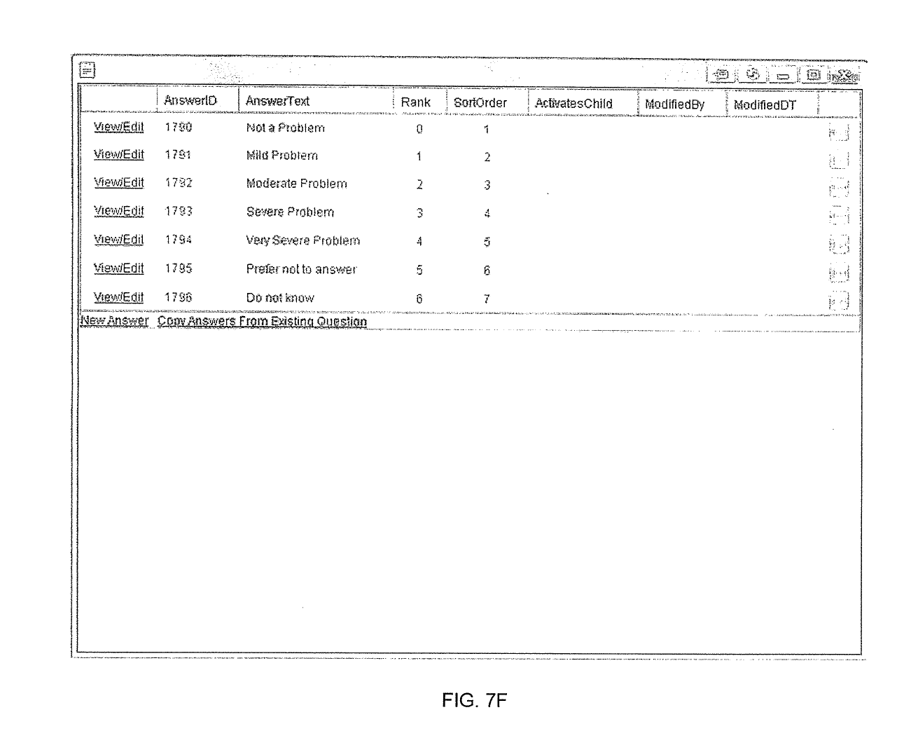

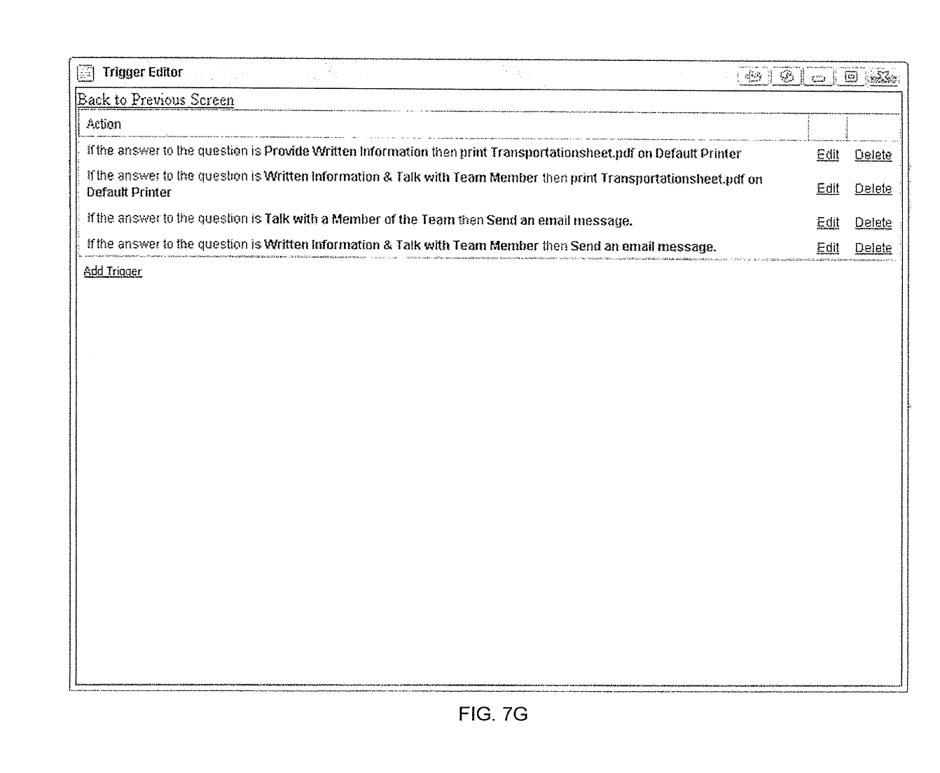

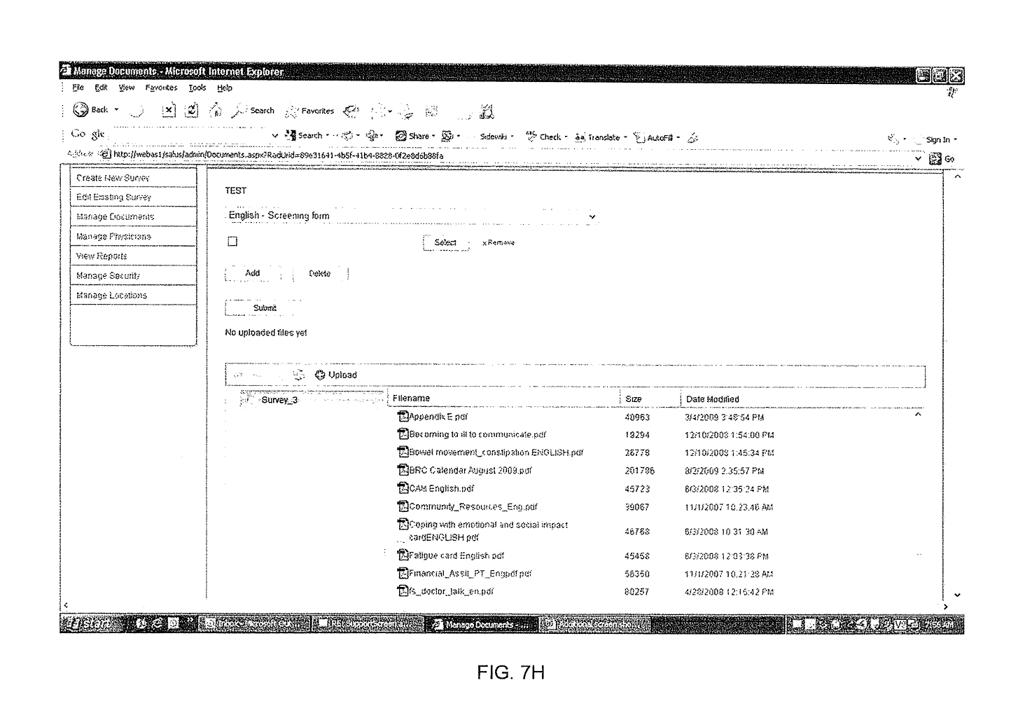

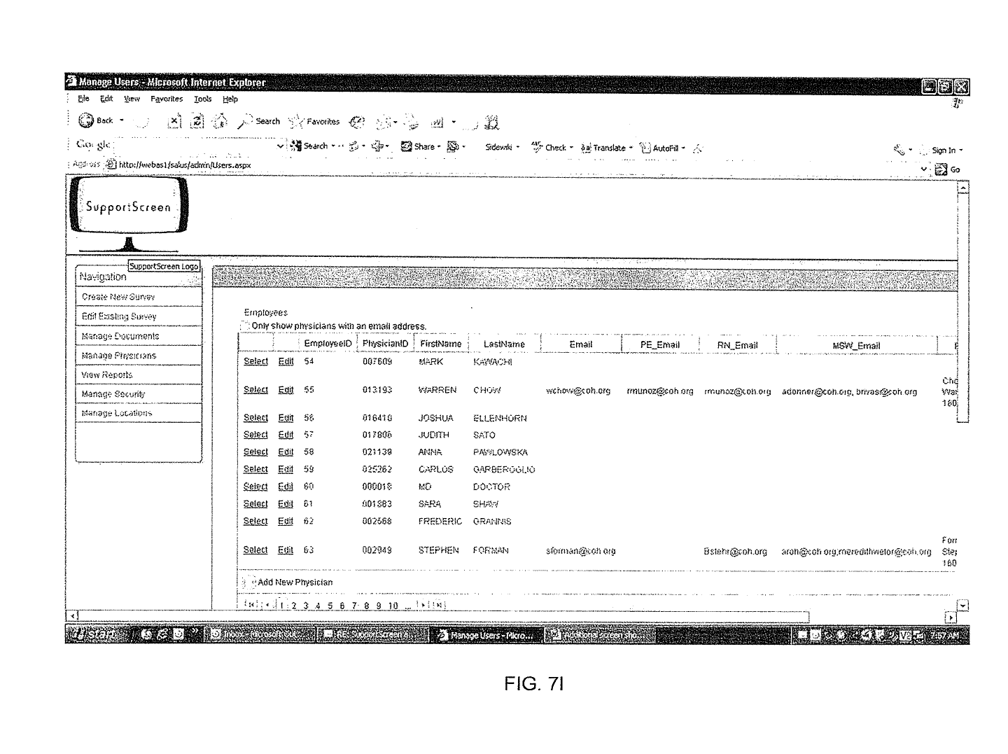

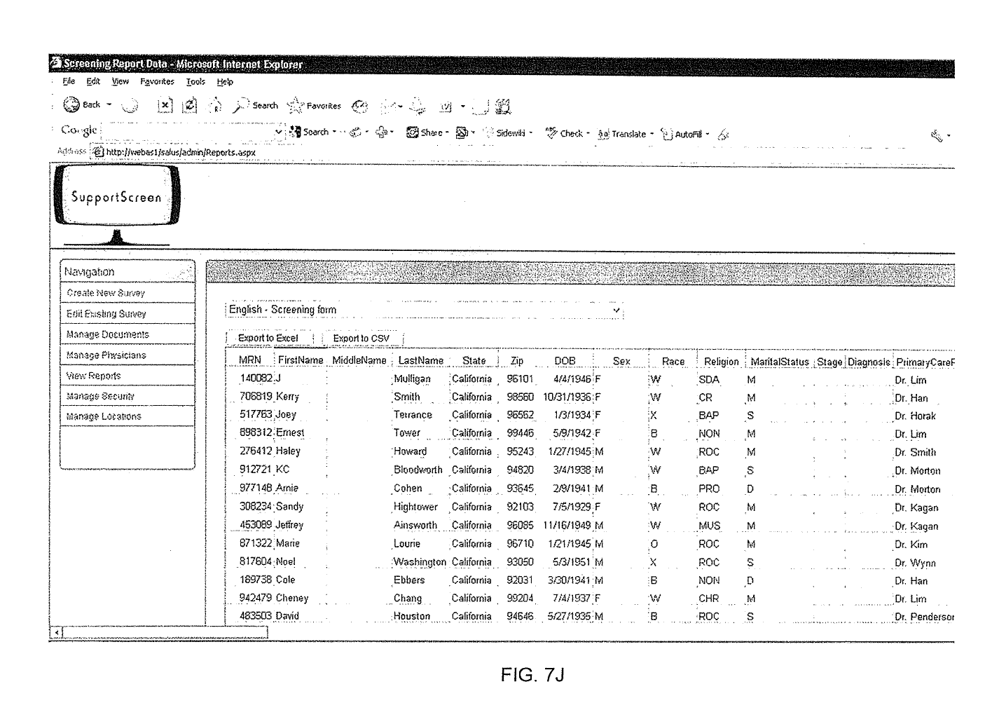

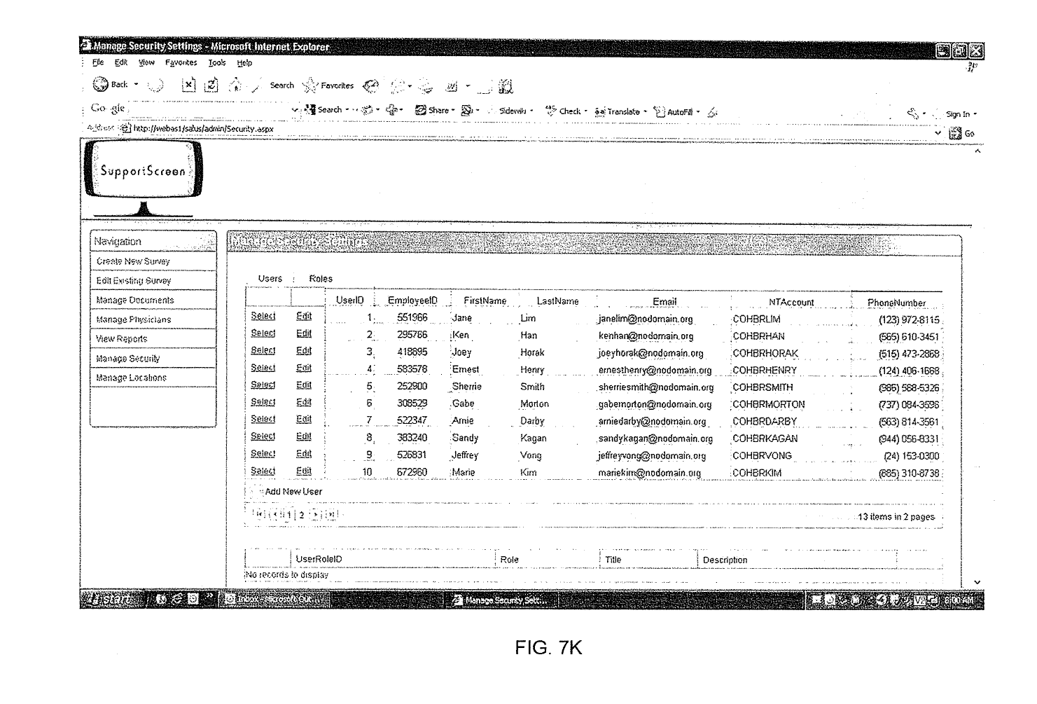

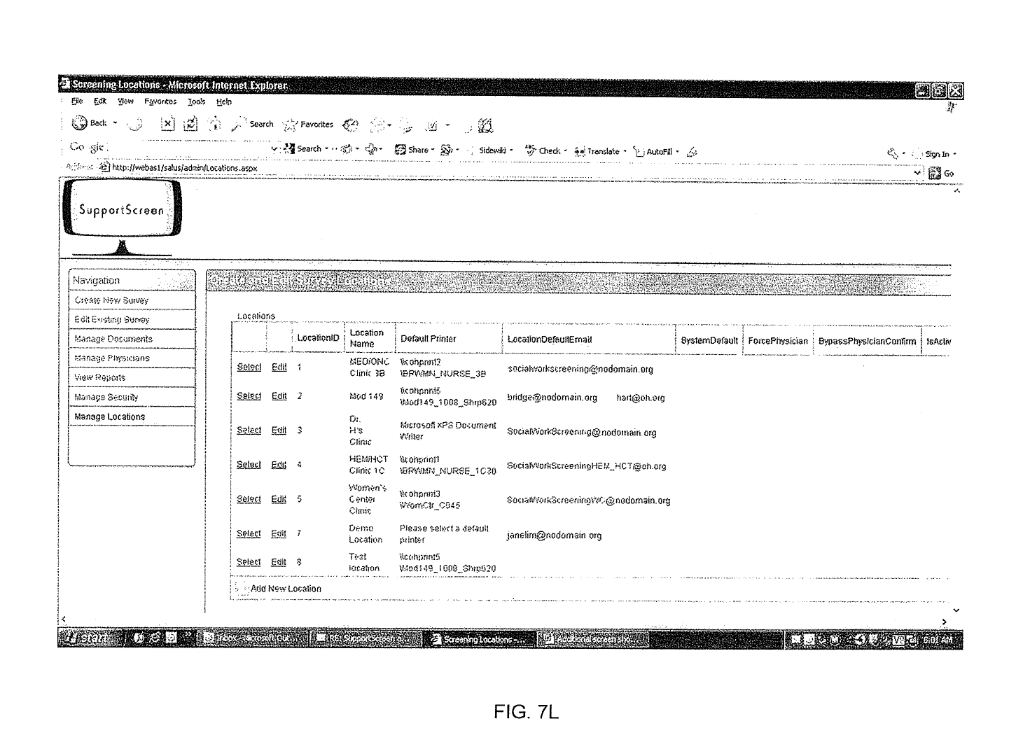

In accordance with an aspect of the invention and with reference to FIGS. 2 and 7A-7L, screening instrument system 250 includes a screening instrument management module. In one embodiment, the management module includes computer program instructions and structured data stored on server 160. As exemplified in FIGS. 7A-7L, the management module can include a web-based user interface accessible from, for example, clinic workstation 180 and/or a professional's computer 220. The management module can implemented with web server techniques such that administrators can access the management module using a web browser. Access to the management module can be password protected.

The management module enables a system administrator or professional to configure and control aspects of screening instrument system 250. In one embodiment, as illustrated in FIG. 7A, the management module provides a main navigation bar including administrator selectable links for creating a new survey, editing an existing survey, management documents, managing physicians, viewing reports, managing security and managing locations.

FIG. 7A illustrates a submodule of the management module for creating a new screening instrument (“survey”). Surveys can be grouped according to a group ID and can be created for administration in multiple languages such as English, Spanish and Mandarin Chinese as illustrated in FIG. 7A. For example, the manager can configure the system to categorize patients' responses during the patient interaction protocol according to programmable triage criteria. The management module further includes a sub-module for modifying an existing screening instrument as illustrated in FIG. 7B. Surveys are stored on a storage device accessible to server 160.

As discussed above, a screening instrument can include a letter from a physician to the patient such as that illustrated in FIG. 5A. As shown in FIG. 7C, the letter can include placeholders for personalizing the letter so that a particular doctor's name and/or photograph and a particular patient's name can be substituted for the placeholders [[doctorphoto]] and [[patientfirstname]]. Screening system 250 is configured to substitute a patient name and physician information when the letter is presented to the patient on PID 100, as illustrated in FIG. 5A.

As illustrated in FIG. 7D, the management module can provide an interface for editing a survey draft which provides for creating, deleting and editing questions, issues, and prompts to be presented to the patient as part of the screening instrument. Questions comprise question text, answers and, optionally, triggers. Optionally, relationships between questions can be configured through the interface to indicate order of question delivery and whether a question is dependent on a response to another question. For example, as illustrated in FIG. 7D, the question, “How much of a problem is this for you? Transportation” has a child-question, “how can we best work with you on this problem?” FIG. 5B illustrates how this question and sub-question can be presented to the patient. In one embodiment, the sub-question would not be presented to the patient on the condition that certain responses, “not a problem” or “prefer not to answer” are selected.

As illustrated in FIG. 7E, the management module has a submodule for creating and editing questions. The question text can be edited in a WYSIWIG subwindow enabling the administrator to visualize and control the question's fonts, font sizes, color and styles. As an option, the editing can be performed using HTML and subsequently previewed as it should appear on a PID 100 screen. The submodule provides for setting and recording additional attributes of a question. For example, the administrator can indicate that an answer to the question must be provided by a patient by checking the “ResponseRequired” check box. The submodule can also provide for the administrator to indicate the type of questions, for example, multiple choice, yes/no, multiple answer, and so on. The submodule can optionally provide for recording creation and modification times and an identity associated with the administrator creating and modifying the question.

As illustrated in FIG. 7F, the management module also includes a submodule for managing and editing response choices available for a given question. In addition to the text for the response, responses can also include attributes for sort order, i.e., the order in which the responses will appear on the screen of PID 100, “rank,” a value which can be associated with a triage trigger, and whether the response will activate a child question. The submodule can further include a feature allowing responses to be copied to the current question from another question already in the questions database.

With reference to FIG. 7G, the management module also provides a trigger management submodule for entering rules with regard to automated actions to be taken, e.g., triage and requested information, if the patient makes certain responses. For example, if the question is regarding transportation and the patient has selected the response “Provide Written Information,” then screening system 250 will retrieve Transportationsheet.pdf from a document store and print it on the “Default Printer.” In another example, if a patient were to respond to question “Seriously considering taking my own life” with response “Often,” and response “Often” was associated with rank 3, then a rule such as “If the response to the question is rank 3 or greater then send an email message to MD and cc MSW.” The trigger management submodule also includes user selectable links for adding, editing and deleting a trigger. Server 160 is coupled to a data store 260 for storing documents which can be automatically retrieved and printed in response to a patient request for additional information.

Triage criteria can be associated with each of the issues. Triage criteria should be set based on the specific needs of patients, current resources available and staffing levels. In screening instrument system 250, each item can be precoded and electronically transmitted to a specific professional or resource in real-time. In addition, a copy of the notification can be sent to the patient's physician, nurse and/or social worker to ensure effective communication. However, screening instrument system 250 is designed to be highly flexible regarding where and to whom electronic triage information is directed. The NCCN distress management guidelines can be a helpful source of information in the development of triage and intervention.

Each item in the screening instrument can be linked to one or more specific professionals. For example, if a patient reports a Pain distress level of 4 or greater, this response information can be transmitted to the identified physician, nurse, and/or social worker. Problems related to physical symptoms such as Nausea or Recent weight change can be referred to a physician and/or nurse. Problems related to emotional, social, and practical concerns, such as Feeling down or depressed or Feeling hopeless, can be triaged to a social worker for assessment and potential referral to psychology or psychiatry. Each designated health professional can be copied on all e-mails regarding the patient. This electronic transfer of information helps ensure timely communication and clear delineation of responsibility for follow-up.

TABLE 2
Exemplary professionals alerted for exemplary triage issues

| Problem-related distress | Primary | CC |
|---|---|---|
| Sleeping | PE | MD/MSW |
| Talk with MD | MD | PE/MSW |
| Understanding Treatment Options | MD | PE/MSW |
| Talking with Health Care Team | MSW | MD/PE |
| Ability to have Children | MD | PE/MSW |
| Controlling my urine or stool | PE | MD/MSW |
| Swelling | PE | MD/MSW |
| Walking, climbing stairs | PE | Rehab/MD/MSW |
| Pain! | MD | PE/MSW |
| Side-effects of treatments | PE | MD/MSW |
| Substance use-you or your environment | MD | PE/MSW |
| Joint Limitations (including your jaw) | PE | Rehab/MD/MSW |

Under actual patient use conditions, the inventors have observed that patients' responses have triggered referrals in approximately 77% of the population. Each problem was directed to the appropriate health care team member for triage. For example, if a patient reported a pain distress level >4, this information was immediately sent to the nurse, doctor and/or social worker. The items pain and thoughts of ending my own life were flagged and considered “hot buttons” which required immediate attention from a health care team member.

Professionals receiving real time triage alerts can include the patient's primary health care team, physicians, nurses, and social workers. Additionally, certain consultants may be able to assist the patient with issues identified in the screening process, including, for example, clinical nutritionists, cosmetologists, health educators, patient navigators, pain and palliative care team, psychologists, psychiatrists, physical therapists pharmacists, researchers, and spiritual counselors.

With reference to FIG. 7H, the management module can include a document management submodule for enabling an administrator to upload and delete document files and for associating the files with a survey.

As illustrated in FIG. 7I, the management module also provides a submodule to manage the identity and e-mails addresses of professionals and physicians, for example, who will receive reports and e-mail from screening system 250. A patient responding to the screening instrument can be associated with a single physician, who in turn can be associated with additional professionals. Thus, when triage information is generated, it can be transmitted to the proper professional associated with the patient and the particular issue being triaged. As illustrated in FIG. 7I, multiple e-mail addresses can be provided for any e-mail address field.

FIG. 7J illustrates a screening form results list which lists patients who have completed a screening instrument. Demographic information regarding the patients may have been transferred from a Patient Medical Record System 830 as illustrated in FIG. 8. In one embodiment, such transfer is effected based on the patient's Medical Record Number (MRN). As illustrated, patient information can include a religious affiliation which would be pertinent to a patient response indicating that the patient has religious or spiritual concerns. Also, the screening form results list and underlying response data can be exported in user selectable formats such as Excel and CSV.

As illustrated in FIG. 7K, the management module can also include a security settings submodule. This submodule enables an administrator to add and delete authorized users of screening system 250 and to edit their information and privilege settings. Embodiments of the invention can include security aspects. For example, patient information can be MRN encrypted. There can be differing controlled levels of access to system features and response data. Access to particular patient information can be restricted to persons possessing requisite security credentials and/or other information, such as medical record number, patient name and date of birth. Also, aspects of screening system 250 and server 160 can be firewalled from outside networks.

As illustrated in FIG. 7L, the management module also includes a locations management submodule. This submodule enables the administrator to manage details regarding each location for which screening system 250 is deployed. That is, with reference to FIG. 2, screening system 250 can comprise multiple workstations 180, printers 200 and PIDs 100 in geographically separated offices and clinics. The locations management submodule allows the administrator to specify default e-mail addresses and printers for each deployment location.

Screening instrument system 250, including PID 100, can be implemented as a web-based system. The screening instrument system 250 can utilize, for example, the .NET platform from Microsoft Corporation and/or JavaScript. PID 100 can access Active Server Pages (ASP) stored on server 160 and written with VBscript and/or using JavaScript. Survey questions, patient responses, and patient information documents can be stored in one or more databases 820 or other data stores 260. Patient response information in such a database can facilitate clinical research. Databases can be configured for export for such purposes. The databases can be relational databases accessible using SQL. Patient information can also be formatted as HL7 based messages. Use of SQL and HL7 can facilitate linking other systems with screening instrument system 250. Standardized coding, such as ICD-9 or ICD-10 codes, can be correlated with survey questions and patient responses and can be linked to items on a physician report. Table 3 illustrates exemplary ICD-9 codes:

TABLE 3
Exemplary encoding

| Problem-related distress | ICD-9 Code |
|---|---|
| Sleeping | 780.52 |
| Talk with MD | V65.49 |
| Understanding Treatment Options | V65.49 |
| Talking with Health Care Team | V65.49 |
| Ability to have Children | V65.49 |
| Controlling my urine or stool | 788.30 & 787.6 |
| Swelling | 782.3 |
| Walking, climbing stairs | 719.7 |
| Pain | 780.96 |
| Side-effects of treatments | V65.49 |
| Substance use-you or your environment | V65.42 |
| Joint Limitations (including your jaw) | 719.58 |
| Fatigue | 780.79 |
| Bowel movement/constipation | 564.00 |
| Sexual function | 627.2 (Female) |
| | 607.84 (Male) |
| Thoughts of ending my own life | |
| Nausea and vomiting | 787.01 |
| Speech | 784.5 |
| Tobacco use | 305.1 |

Screening instrument system 250 relates to the entire process—from initiation of patient responses on the touch screen to the generation of referrals and provision of resources and educational information in real time. Patients can complete their interaction with the screening instrument on PID 100 before meeting with their physician. As a result of patients' responses to the screening instrument, the screening instrument system can provide for five potential outputs, all in real time: 1) a Summary Report for the physician transmitted electronically and/or printed; 2) tailored, written educational information for patients; 3) personalized resources to patients; 4) criteria-driven referrals to professionals and community-based resources; and 5) individual patient responses recorded into a database for analysis.

Although various embodiments of the present invention have been shown and described above, it will be appreciated by those skilled in the art that changes can be made in these embodiments without departing from the principle and spirit of the invention, the scope of which is defined by the appended claims and their equivalents.

What is claimed is:

1. An individual screening and triage system comprising:
a patient interactive device;
an administrative server;
a data network operatively connected to at least the patient interactive device and the administrative server, wherein issues and prompts are directed from the administrative server over the data network to the patient interactive device and responses are received at the administrative server from the patient interactive device; and
a triage module,
wherein the patient interactive device presents the issues and related possible prompts to a user of the patient interactive device and transmits the user responses over the data network;
wherein the user responses can include data and information related to the presented issue;
wherein the administrative server receives the transmitted data and information for storage into a patient record; and
wherein the triage module is configured to compare a user's response data and information with a set of triage rules and, if the response triggers a triage message, automatically generate and transmit a triage message indicating a patient exigency to a communication device of a member of the user's care team.

2. The individual screening and triage system according to claim 1, wherein the user can comprise a patient, a family member of a patient, a member of a patient's health care team, or a member of a patient's caregiving team.

3. The individual screening and triage system according to claim 1, wherein the system receives feedback regarding actions taken on behalf of the user, wherein a message is automatically generated and transmitted to at least one member of the user's caregiving team if an action was not timely or completely performed.

4. A screening instrument system comprising:
a patient interactive device coupled with a data network;
an administrative server coupled with the data network, the administrative server operatively connected to a database and a printer, wherein the administrative server is configured to serve as a screening instrument to the patient interactive device and to receive responsive information from the patient interactive device; and
a triage module,
wherein the screening instrument comprises a plurality of issues, each issue having a patient prompt and one or more patient selectable responses;
wherein the patient interactive device is operable to, for each issue in the screening instrument, display the related patient prompt, receive an indication of a patient selection of a related patient selectable response and transmit information representing the indication to the administrative server; wherein the administrative server is configured to receive the information and store a patient response record comprising the information received; and
wherein the triage module is configured to compare a particular patient's response information with a set of triage rules and perform at least one of the following: (1) generate and transmit a triage message indicating a patient exigency to a communication device of a member of the patient's professional health care team, the communication device operatively connected to the data network, and (2) generate and transmit a message indicating the patient's request to discuss an issue with a member of the patient's professional health care team to the communication device.

5. The screening instrument system according to claim 4, wherein the triage module is further configured to generate and transmit a summary report of the patient's response record to one or more of the communication device and a printer.

6. The screening instrument system according to claim 4, wherein the patient interactive device comprises a touch screen computer.

7. The screening instrument system according to claim 4, wherein an issue can further comprise a triage threshold and identify a triage alert professional, wherein the triage message is transmitted to a communication device of the identified triage alert professional when a patient response to an issue matches or exceeds the triage threshold associated with the issue.

8. The screening instrument system according to claim 4, wherein an issue further comprises information identifying an educational item, and the administrative server is further configured to retrieve the identified educational item from an educational item store and to transmit the educational item to a printer or to a location selected by the patient in response to information representing the patient's desire for additional information.

9. The screening instrument system according to claim 4, wherein a message is automatically generated and transmitted to at least one of the patient's caregiving team should a recommended action not be timely or completely performed.

10. A method of administering a screening instrument, the method comprising the steps of:
storing a screening instrument in an electronic screening instrument store, the electronic screening instrument store operatively connected to an administrative server, the screening instrument comprising a plurality of issues, each issue having a patient prompt and one or more patient selectable responses;
transmitting, by the administrative server, one or more issues to a patient interactive device via a data network;
receiving from the patient interactive device, by the administrative server, patient responses representing a patient's selected responses to the screening instrument items;
storing, in a database, the responses as an electronic patient record; and
triaging, by the administrative server, the triaging comprising electronically comparing one or more data representing the patient's responses with a set of triage rules and performing at least one of the following: (1) electronically generating and transmitting an triage message indicating a patient exigency to a communication device of a member of the patient's professional health care team, the communication device operatively connected to the data network, and (2) electronically generating and transmitting a message indicating the patient's request to discuss an issue with a member of the patient's professional health care team to the communication device.

11. The method according to claim 10, wherein the step of triaging further comprises generating and transmitting a summary report of the patient's responses to one or more of the communication device and a printer.

12. The method according to claim 10, wherein the patient interactive device comprises a touch screen computer.

13. The method according to claim 10, wherein an issue can further comprise a triage threshold and identify a triage alert professional, wherein the triage message is transmitted to a communication device of the identified triage alert professional when a patient response to an issue matches or exceeds the triage threshold associated with the issue.

14. The method according to claim 10, wherein an issue further comprises information identifying an educational item, the method further comprising:
retrieving, by the administrative server, an educational item from an electronic educational item store in response to information representing the patient's desire for additional information; and
transmitting the educational item to a printer or to a location selected by the patient.

15. The method according to claim 10, wherein a message is automatically generated and transmitted to at least one of the patient's caregiving team should a recommended action not be timely or completely performed.

16. A computer-readable medium encoded with computer-executable instructions, which, when executed by a computer, provide for administering a patient screening instrument, wherein the instructions provide for:
retrieving a patient screening instrument from an electronic screening instrument store, the patient screening instrument comprising a plurality of issues, each issue comprising a patient prompt and one or more patient selectable responses;
transmitting one or more issues to a patient interactive device via a data network;
receiving from the patient interactive device patient response data representing a patient's responses to the screening instrument issues; and
triaging, wherein triaging comprises electronically comparing data representing the patient's responses with a set of triage rules and performing at least one of the following: (1) electronically generating and transmitting an triage message indicating a patient exigency to a communication device of a member of the patient's professional health care team, the communication device operatively connected to the data network, and (2) electronically generating and transmitting a message indicating the patient's request to discuss an issue with a member of the patient's professional health care team to the communication device.

17. The computer-readable medium according to claim 16, wherein the computer executable instructions for triaging further comprise instructions for generating and transmitting a summary report of the patient's responses to one or more of the communication device and a printer.

18. The computer-readable medium according to claim 16, wherein an issue can further comprise a triage threshold and identify a triage alert professional and wherein the computer executable-instructions further comprise instructions for transmitting the triage message to a communication device of the identified triage alert professional when a patient response to an issue matches or exceeds the triage threshold associated with the issue.

19. The computer-readable medium according to claim 16, wherein an issue further comprises information identifying an educational item, the computer executable instructions further comprising instructions for:
retrieving the educational item from an educational item store in response to information representing the patient's desire for additional information; and
transmitting the educational item to a printer.

20. The computer-readable medium according to claim 16, wherein a message is automatically generated and transmitted to at least one of the patient's caregiving team should a recommended action not be timely or completely performed.
